(19) United States
(12) Patent Application Publication
(10) Pub. No.: US 2004/0220054 A1
(43) Pub. Date: Nov. 4, 2004

(54) Recording material

(75) Inventors: Akinori Fujita, Shizuoka-ken (JP); Hisato Nagase, Shizuoka-ken (JP); Toshihide Aoshima, Shizuoka-ken (JP); Kimi Ikeda, Shizuoka-ken (JP); Satoru Yamada, Shizuoka-ken (JP); Hiroshi Sato, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/832,232

(22) Filed: Apr. 27, 2004

(30) Foreign Application Priority Data
Apr. 30, 2003 (JP) 2003-124664
Mar. 23, 2004 (JP) 2004-84960

(51) Int. Cl. B41M 5/20

(52) U.S. Cl. 503/200

(57) ABSTRACT

The present invention provides a recording material including a support having disposed thereon a recording layer that contains a diazo compound and a compound represented by formula (1):

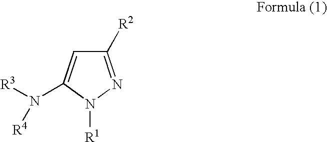

wherein, in formula (1), R¹ represents a hydrogen atom or an optionally substituted alkyl, aryl, alkylsulfonyl, arylsulfonyl, acyl, carbamoyl, acylamino, alkylsulfonylamino, arylsulfonylamino, alkoxycarbonyl or aryloxycarbonyl group; R² represents a hydrogen atom or an optionally substituted alkyl, aryl, alkoxy, aryloxy, amino, alkoxycarbonyl, aryloxycarbonyl, carbamoyl, acylamino, alkylsulfonylamino or arylsulfonamino group; and R³ and R⁴ each independently represent a hydrogen atom or an optionally substituted alkyl, aryl, alkylsulfonyl, arylsulfonyl, acyl, carbamoyl or heterocyclic group, or may be bonded to each other to form a ring.

### CROSS-REFERENCE TO RELATED APPLICATION

This application claims priority under 35 USC 119 from Japanese Patent Application Nos. 2003-124664 and 2004-84960, the disclosures of which are incorporated by reference herein.

### BACKGROUND OF THE INVENTION

1. Field of the Invention

The present invention relates to a recording material using, as a color forming component, a combination of a diazo compound and a pyrazole type coupler. More specifically, the invention relates to a yellow-color developing-type recording material that is excellent in pre-recording storability (raw stock storability) and post-recording image storability (light fastness).

2. Description of the Related Art

Diazo compounds react with compounds called “couplers”, such as phenol derivatives or the compounds having an active methylene group, to form azo dyes. These diazo compounds also have properties such that they decompose when irradiated with light and thereby lose their activity. Conventionally, these diazo compounds have been utilized as optical recording materials, typified by diazo copies, by making use of such properties (see, for example, “Fundamentals of Photographic Engineering: Non-silver Salt Photography” edited by the Photographic Society of Japan, Corona Publishing Co., Ltd., 1982, pp.89-117 and pp.182-201).

Recently, these diazo compounds have also been applied to recording materials of which image fixation is demanded. As a representative example, a photo-fixing type heat-sensitive recording material has been proposed, in which a diazo compound and a coupler compound are subjected to heating according to image signals to thereby cause a reaction between the two compounds to form an image, followed by irradiation with light to fix the thus formed image (see, for example, SATO Koji et al., “Journal of the Institute of Image Electronics Engineers of Japan” Vol. 11, No. 4, 1982, pp.290-296).

These recording materials, however, have the drawback that their shelf lives as recording materials are short because the active diazo compound is gradually decomposed to gradually lose its reactivity even in a dark environment. In order to alleviate this drawback, another method has been proposed in which a diazo compound is encapsulated in microcapsules so as to separate the diazo compound from other components, such as water and a base, which facilitate decomposition. This method makes it possible to improve the shelf life of the recording material considerably (see, for example, USAMI Tomomasa et al., “Journal of Electrophotography Society” Vol. 26, No. 2, 1987, pp. 115-125).

Microcapsules having a glass transition temperature that is higher than ambient temperature may be suitably used in heat-sensitive recording materials to act as the heat-responsive microcapsules, because the walls of the capsules do not exhibit material-permeability at ambient temperature, whereas they do exhibit material-permeability at a temperature higher than the glass transition temperature. Namely, a heat-sensitive recording material comprising a support having disposed thereon a heat-sensitive recording layer that contains heat-responsive microcapsules in which a diazo compound is included, a coupler compound and a base can achieve (1) improvement in the long-term stable storability of the diazo compound; (2) development and formation of a color image by heating; and (3) fixation of the formed image by irradiation with light.

Attempts have been made to heighten performance of such heat-sensitive recording materials, such as recording materials that form a multicolor image (see Japanese Patent Application Laid-Open (JP-A) Nos. 04-135787 and 04-144784). Concomitant with these attempts, improvement in pre-recording storability and post-recording light fastness at an image area and a non-image area is desired.

For example, a method has been proposed in which an acetoacetanilide coupler compound is used as the coupler so as to obtain a yellow image (see, for example, JP-A No. 04-201483). However, this method using the acetoacetanilide compound has the drawback that light fastness at the image area is low.

### SUMMARY OF THE INVENTION

It is therefore an object of the present invention to provide a recording material using, as a color forming component, a combination of a diazo compound and a coupler, that has improved the pre-recording storability and post-recording light fastness at an image area and a non-image area.

In view of the above-described circumstances, the present inventors have conducted intensive research and found that if a compound represented by the following formula (1) is used as a coupler, a yellow-color developing-type recording material that has improved pre-recording storability and post-recording light fastness at an image area and a non-image area can be obtained, to thereby accomplish the present invention.

More specifically, the present invention provides a recording material which comprises a support having disposed thereon a recording layer that contains a diazo compound and a compound represented by the following formula (1):

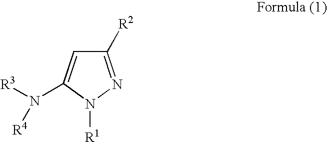

wherein, in formula (1), R¹ represents a hydrogen atom or an optionally substituted alkyl, aryl, alkylsulfonyl, arylsulfonyl, acyl, carbamoyl, acylamino, alkylsulfonylamino, arylsulfonylamino, alkoxycarbonyl or aryloxycarbonyl group; R² represents a hydrogen atom or an optionally substituted alkyl, aryl, alkoxy, aryloxy, amino, alkoxycarbonyl, aryloxycarbonyl, carbamoyl, acylamino, alkylsulfonylamino or arylsulfonamino group; and R³ and R⁴ each independently represent a hydrogen atom or an optionally substituted alkyl, aryl, alkylsulfonyl, arylsulfonyl, acyl, carbamoyl or heterocyclic group, or may be bonded to each other to form a ring.

### DETAILED DESCRIPTION OF THE INVENTION

Hereinafter, the present invention will be explained in more detail.

<Coupler>

The coupler used in the heat-sensitive recording material of the present invention is represented by the following formula (1).

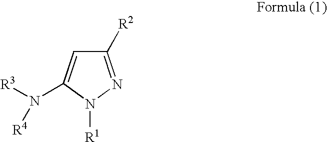

In formula (1), R¹ represents a hydrogen atom or an optionally substituted alkyl, aryl, alkylsulfonyl, arylsulfonyl, acyl, carbamoyl, acylamino, alkylsulfonylamino, arylsulfonylamino, alkoxycarbonyl or aryloxycarbonyl group; R² represents a hydrogen atom or an optionally substituted alkyl, aryl, alkoxy, aryloxy, amino, alkoxycarbonyl, aryloxycarbonyl, carbamoyl, acylamino, alkylsulfonylamino or arylsulfonylamino group; and R³ and R⁴ each independently represent a hydrogen atom or an optionally substituted alkyl, aryl, alkylsulfonyl, arylsulfonyl, acyl, carbamoyl or heterocyclic group, or may be bonded to each other to form a ring.

Among the compounds represented by formula (1), the compounds in which R⁴ represents a hydrogen atom are preferable.

Also, among the compounds represented by formula (1), the compounds represented by the following formula (1-2) are preferable:

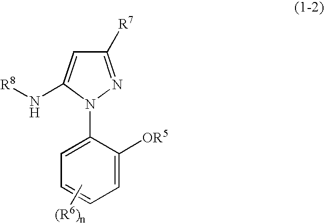

wherein, in formula (1-2), R⁵ represents a hydrogen atom or an optionally substituted alkyl or aryl group; R⁶ represents a substituent; R⁷ represents a hydrogen atom or an optionally substituted alkyl, aryl, alkoxy, aryloxy, amino, alkoxycarbonyl, aryloxycarbonyl, carbamoyl, acylamino, alkylsulfonylamino or arylsulfonylamino group; R⁸ represents a hydrogen atom or an optionally substituted alkyl, aryl, alkylsulfonyl, arylsulfonyl, acyl, carbamoyl or heterocyclic group; and n indicates an integer of 0 to 4.

Among the compounds represented by formula (1-2), the compounds represented by the following formulae (1-3), (1-4) or (1-5) are still more preferable:

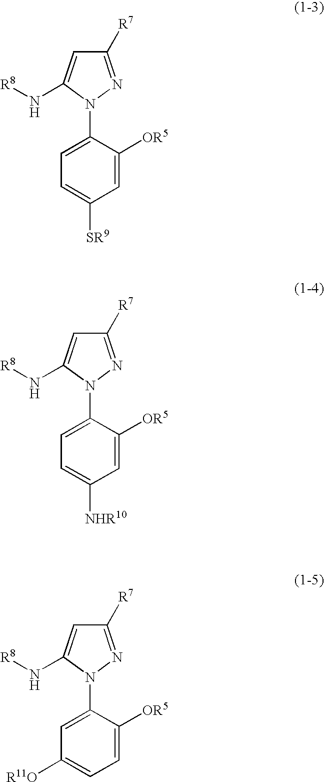

wherein, R⁹ represents an optionally substituted alkyl or aryl group; R¹⁰ represents an optionally substituted acyl, alkylsulfonyl, arylsulfonyl, carbamoyl, alkoxycarbonyl or aryloxycarbonyl group; R¹¹ represents an optionally substituted alkyl or aryl group; R⁷ represents a hydrogen atom or an optionally substituted alkyl, aryl, alkoxy, aryloxy, amino, alkoxycarbonyl, aryloxycarbonyl, carbamoyl, acylamino, alkylsulfonylamino or arylsulfonylamino group; and R⁸ represents a hydrogen atom or an optionally substituted alkyl, aryl, alkylsulfonyl, arylsulfonyl, acyl, carbamoyl or heterocyclic group.

In formula (1), as the alkyl group represented by R¹ to R⁴, alkyl groups having 1 to 25 carbon atoms are preferable. Examples of such an alkyl group include a methyl group, ethyl group, propyl group, isopropyl group, n-butyl group, sec-butyl group, t-butyl group, pentyl group, heptyl group, n-octyl group, 2-ethylhexyl group, t-octyl group, nonyl group, decyl group, dodecyl group, tridecyl group, tetradecyl group, pentadecyl group, n-hexadecyl group, 2-hexyldecyl group, heptadecyl group, octadecyl group, nonadecyl group, and icosyl group.

The alkyl group may further have a substituent. As the substituent, a phenyl group, halogen atom, alkoxy group, aryloxy group, alkoxycarbonyl group, aryloxycarbonyl group, acyloxy group, acylamino group, carbamoyl group, cyano group, carboxylic acid group, sulfonic acid group, or heterocyclic group is preferabe.

As the (substituted) alkyl group represented by R¹ to R⁴, examples include a methyl group, ethyl group, n-propyl group, isopropyl group, n-butyl group, isobutyl group, t-butyl group, n-pentyl group, isopentyl group, cyclopentyl group, hexyl group, cyclohexyl group, heptyl group, octyl group, t-octyl group, 2-ethylhexyl group, decyl group, dodecyl group, octadecyl group, 2-hydroxyethyl group, 2-benzoyloxyethyl group, 2-(4-butoxyphenoxy)ethyl group, benzyl group, allyl group, methoxyethyl group, ethoxyethyl group, dibutylaminocarbonylmethyl group, trichloromethyl group, phenylethyl group, ethoxyethyl group, phenoxyethl group, methoxycarbonylpropyl group, acetyloxyethyl group, N-butylcarbamoylethyl group, acetylaminoethyl group, 2-cyanobutyl group, and furfuryl group. More preferable examples include a methyl group, ethyl group, n-propyl group, isopropyl group, n-butyl group, isobutyl group, t-butyl group, n-hexyl group, n-octyl group, 2-ethylhexyl group, t-octyl group, and phenylethyl group. Particularly preferable examples include a methyl group, ethyl group, n-propyl group, t-butyl group, and n-hexyl group.

As the aryl group represented by R¹ to R⁴, aryl groups having 6 to 30 carbon atoms are preferable. Suitable examples of the aryl group include a phenyl group, naphthyl group, and pyridyl group.

The aryl group may further have a substituent. As the substituent, for example, a phenyl group, halogen atom, alkoxy group, aryloxy group, alkoxycarbonyl group, aryloxycarbonyl group, acyloxy group, acylamino group, carbamoyl group, cyano group, carboxylic acid group, sulfonic acid group, heterocyclic group, alkylthio group, arylthio group, aryloxycarbonyl group, alkoxycarbonylamino group, aryloxycarbonylamino group, carbamoylamino group, amino group or nitro group is preferable.

As the (substituted) aryl group represented by R¹ to R⁴, a phenyl group, naphthyl group, 4-chlorphenyl group, 4-methylphenyl group, 4-butoxyphenyl group, 2-methoxyphenyl group, 2-hydroxyphenyl group, 2-hydroxy-5-octylphenyl group, 2,5-diheptyloxyphenyl group, 2-hydroxy-5-butoxyphenyl group, 2-decyloxyphenyl group, 4-methoxyphenyl group, 2-octyloxynaphthyl group, dimethylaminophenyl group, 2-dodecythiophenyl group, 4-methylphenylthiophenyl group, 2,5-dioctyloxyphenyl group, 2-methoxy-4-dodecylthiophenyl group, 2,5-dibutyloxy-4-nitrophenyl group, 2-phenoxyethoxyphenyl group, 2-dodecyloxyphenyl group, 2-octadecyloxyphenyl group, 2,5-dibenzyloxyphenyl group, 2,5-dicyclohexylmethyloxyphenyl group, 2-methoxy-4-(2-ethylhexanoylamino)phenyl group, 2-butoxy-4-benzoyloxycarbonylamino group, and 2-octyloxy-4-butyloxycarbonylamino group. More preferable examples include a phenyl group, naphthyl group, 2-methoxyphenyl group, 2-decyloxyphenyl group, 4-methoxyphenyl group, 2-octyloxynaphthyl group, dimethylaminophenyl group, 2-dodecythiophenyl group, 4-(4-methylphenylthioxy)phenyl group, 2-methoxy-4-dodecylthioxyphenyl group, 2-phenoxyethoxyphenyl group, 2-dodecyloxyphenyl group, 2-octadecyloxyphenyl group, 2,5-dibenzyloxyphenyl group, 2,5-dicyclohexylmethyloxyphenyl group, 2-methoxy-4-(2-ethylhexanoylamino)phenyl group, 2-butoxy-4-benzyloxycarbonylaminophenyl group, and 2-octyloxy-4-butyloxycarbonylaminophenyl group.

As the alkylsulfonyl group represented by R¹ to R⁴, alkylsulfonyl groups having 1 to 20 carbon atoms are preferable. Examples of such an alkylsulfonyl group include a methylsulfonyl group, ethylsulfonyl group, propylsulfonyl group, butylsulfonyl group, octylsulfonyl group, decylsulfonyl group, and dodecylsulfonyl group.

The alkylsulfonyl group may further have a substituent. As the substituent, for example, a phenyl group, halogen atom, alkoxy group, aryloxy group, alkoxycarbonyl group, aryloxycarbonyl group, acyloxy group, acylamino group, carbamoyl group, cyano group, carboxylic acid group, sulfonic acid group or heterocyclic group is preferable.

As the (substituted) alkylsulfonyl group, a methylsulfonyl group, butylsulfonyl group, octylsulfonyl group, decylsulfonyl group, dodecylsulfonyl group, benzylsulfonyl group, phenylmethysulfonyl group, trichloromethylsulfonyl group, ethoxyethylsulfonyl group, or phenoxyethylsulfonyl group is preferable. More preferable examples include a methylsulfonyl group, n-butylsulfonyl group, n-octylsulfonyl group, phenylmethylsulfonyl group, and trichloromethylsulfonyl group. Particularly more preferable examples include a methylsulfonyl group, n-octylsulfonyl group, and trichloromethylsulfonyl group.

As the arylsulfonyl group represented by R¹ to R⁴, arylsulfonyl groups having 6 to 30 carbon atoms are preferable. Examples of such an arylsulfonyl group include a benzenesulfonyl group.

The arylsulfonyl group may further have a substituent. As the substituent, for example, an alkyl group, phenyl group, halogen atom, alkoxy group, aryloxy group, alkoxycarbonyl group, aryloxycarbonyl group, acyloxy group, acylamino group, carbamoyl group, cyano group, carboxylic acid group, sulfonic acid group or heterocyclic group is preferable.

As the (substituted) arylsulfonyl group, a benzenesulfonyl group, toluenesulfonyl group, chlorobenzenesulfonyl group, butoxybenzenesulfonyl group, 2,5-dibutoxybenzenesulfonyl group, dichlorobenzenesulfonyl group, naphtylsulfonyl group, dimethylaminobenzenesulfonyl group, or ethoxycarbonylbenzenesulfonyl group is preferable. More preferable examples include a phenylsulfonyl group, toluenesulfonyl group, chlorobenzenesulfonyl group, and 4-butoxybenzenesulfonyl group. Particularly preferable examples include a phenylsulfonyl group, toluenesulfonyl group, and chlorobenzenesulfonyl group.

As the acyl group represented by R¹, R³ and R⁴, those having 2 to 20 carbon atoms are preferable. A moiety other than a carbonyl group in the acyl group may be any of an aliphatic group, aromatic group and heterocyclic group and may further have a substituent. Examples of the substituent include an alkoxy group, aryloxy group and halogen atom. As the acyl group, an acetyl group, propanoyl group, hexanoyl group, octanoyl group, decanoyl group, dodecanoyl group, octadecanoyl group, benzoyl group, phenoxyacetyl group, 2-ethylhexanoyl group or 2,5-dibutoxybenzoyl group, 2-naphthoyl group, butoxyethanoyl group, trichloroethanoyl group, 4-nitrobenzoyl group or 4-cyanobenzoyl group is preferable. More preferable examples include an ethanoyl group, propanoyl group, butanoyl group, hexanoyl group, 2-ethylhexanoyl group, octanoyl group, decanoyl group, benzoyl group, 4-chlorobenzoyl group, and 4-nitrobenzoyl group. Partcicularly preferable examples include an ethanoyl group, propanoyl group, butanoyl group, hexanoyl group, 2-ethylhexanoyl group, and benzoyl group.

The carbamoyl group represented by R¹ to R⁴ may further have a substituent. As the substituent, an alkyl group, aryl group, alkoxy group, aryloxy group or halogen atom is preferable. As the substituted carbamoyl group, an ethylcarbamoyl group, butylcarbamoyl group, hexylcarbamoyl group, diethylcarbamoyl group, ethoxyethylcarbamoyl group, phenylcarbamoyl group, tolylcarbamoyl group, benzylcarbamoyl group, dimethylcarbamoyl group, dibutylcarbamoyl group, cyclohexylcarbamoyl group, 2-ethylhexylcarbamoyl group, decylcarbamoyl group, methylethylcarbamoyl group, methoxyethylcarbamoyl group, naphthylcarbamoyl group, 4-cyanophenylcarbamoyl group, or 4-nitrophenylcarbamoyl group is preferable. More preferable examples include a dimethylcarbamoyl group, ethylcarbamoyl group, dibutylcarbamoyl group, cyclohexylcarbamoyl group, phenylcarbamoyl group, 2-ethylhexylcarbamoyl group, decylcarbamoyl group, methylethylcarbamoyl group, benzylcarbamoyl group, methoxyethylcarbamoyl group, and naphthylcarbamoyl group. Particular preferable examples include a dimethylcarbamoyl group, ethylcarbamoyl group, dibutylcarbamoyl group, cyclohexylcarbamoyl group, phenylcarbamoyl group, 2-ethylhexylcarbamoyl group, and decylcarbamoyl group.

As the acylamino group represented by R¹ and R², acylamino groups having 2 to 20 carbon atoms are preferable. The acylamino group may further have a substituent. As the substituent, for example, an alkoxy group, aryloxy group, or halogen atom is preferable. Examples of acylamono group include a formylamino group, methanoylamino group, ethanoylamino group, butanoylamino group, hexanoylamino group, decanoylamino group, tetradecanoylamino group, 2-ethylhexanoylamino group, benzylamide group, benzoylamino group, 2,5-dibutoxybenzoylamino group, etoxyethanoylamino group, 4-nitrobenzoylamino group, 2-methoxybenzoylamino group, and phenoxybutanoylamino group. More preferable examples include a methanoylamino group, ethanoylamino group, butanoylamino group, 2-ethylhexanoylamino group, benzoylamino group, decanoylamino group, and etoxyethanoylamino group. Particularly preferable examples include an ethanoylamino group, butanoylamino group, 2-ethylhexanoylamino group, benzoylamino group, and decanoylamino group.

As the alkylsulfonylamino group represented by R¹ and R², alkylsulfonylamino groups having 1 to 20 carbon atoms are preferable. The alkylsulfonylamino group may further have a substituent. As the substituent, for example, an alkoxy group, aryloxy group, halogen atom is preferable. Examples of alkylsulfonylamono group include a methylsulfonylamino group, butylsulfonylamino group, octylsulfonylamino group, decylsulfonylamino group, 2-ethylhexylsulfonylamino group, ethylsulfonylamino group, benzylsulfonylamino group, chloroethylsulfonylamino group, and phenoxyethylsulfonylamino group. More preferable examples include a methylsulfonylamino group, ethylsulfonylamino group, butylsulfonylamino group, octylsulfonylamino group, decylsulfonylamino group, benzylsulfonylamino group, and chloroethylsulfonylamino group. Particularly preferable examples include a methylsulfonylamino group, ethylsulfonylamino group, butylsulfonylamino group, octylsulfonylamino group, decylsulfonylamino group, and benzylsulfonylamino group.

As the arylsulfonylamino group represented by R¹ and R², arylsulfonylamino groups having 6 to 30 carbon atoms are preferable. The acylamino group may further have a substituent. As the substituent, for example, an alkoxy group, aryloxy group, halogen atom is preferable. Examples of arylsulfonylamino group include a phenylsulfonylamino group, 2-butoxyphenylsulfonylamino group, 4-chlorophenylsulfonylamino group, 2,5-diethoxysulfonylamino group, 4-hexyloxyphenylsulfonylamino group, 4-methylphenylsulfonylamino group, naphtylsulfonylamino group, 4-methoxyphenylsulfonylamino group, N-methylphenylsulfonylamino group, and 4-cyanophenylsulfonylamino group. More preferable examples include a phenylsulfonylamino group, 4-methylphenylsulfonylamino group, and naphtylsulfonylamino group. Particularly preferable examples include a phenylsulfonylamino group, and 4-metylphenylsulfonylamino group.

The amino group represented by R² may be unsubstituted, mono-substituted or di-substituted. As the substituent, either an aliphatic group or an aromatic group may be used. The amino group may further have a substituent. As such a substituent, an alkoxy group, aryloxy group or halogen atom is preferable. As the (substituted) amino group, an unsubstituted amino group, butylamino group, hexylamino group, butoxyethylamino group, dibenzylamino group, phenylamino group, phenylmethylamino group, N-methylamino group, N,N-dimethylamino group, N,N-dioctylamino group, N,N-diphenylamino group, N-phenyl-N-methylamino group, N,N-dimethoxyethylamino group, N-benzylamino group, N,N-dibenzylamino group, N,N-diisopropylamino group, or piperidine group is preferable. More preferable examples include an amino group, N-methylamino group, N,N-dimethylamino group, N,N-dioctylamino group, N-phenylamino group, N-benzylamino group, N,N-dibenzylamino group, and N,N-diisopropylamino group. Particularly preferable examples include an amino group, N-methylamino group, N,N-dimethylamino group, N,N-dioctylamino group, N-benzylamino group, N,N-dibenzylamino group, and N,N-diisopropylamino group.

The number of carbons of the alkoxycarbonyl group represented by R¹ and R² is preferably 2 to 20. The alkoxycarbonyl group may further have a substituent. As the substituent, an alkoxy group, aryloxy group, halogen atom or hydroxyl group is preferable. Examples of the alkoxycarbonyl group include a methoxycarbonyl group, ethoxycarbonyl group, butoxycarbonyl group, 2-ethylhexyloxycarbonyl group, decyloxycarbonyl group, ethoxyethoxycarbonyl group, propyloxycarbonyl group, hexyloxycarbonyl group, octyloxycarbonyl group, ethoxybutoxycarbonyl group, phenoxyethoxycarbonyl group, benzyloxycarbonyl group, 4-methylphenylthioxyethoxycarbonyl group, trichloromethylmethyloxycarbonyl group, and 2-cyanopropyloxycarbonyl group. More preferable examples include a methoxycarbonyl group, ethoxycarbonyl group, propyloxycarbonyl group, butoxycarbonyl group, hexyloxycarbonyl group, 2-ethylhexyloxycarbonyl group, octyloxycarbonyl group, decyloxycarbonyl group, ethoxybutoxycarbonyl group, phenoxyethoxycarbonyl group, and benzyloxycarbonyl group. Particularly preferable examples include a methoxycarbonyl group, ethoxycarbonyl group, propyloxycarbonyl group, butoxycarbonyl group, hexyloxycarbonyl group, 2-ethylhexyloxycarbonyl group, octyloxycarbonyl group, decyloxycarbonyl group, and benzyloxycarbonyl group.

The number of carbons of the aryloxycarbonyl group represented by R¹ and R² is preferably 7 to 30. The aryloxycarbonyl group may further have a substituent. As the substituent, an alkoxy group, aryloxy group, halogen atom or hydroxyl group is preferable. Examples of the (substituted) aryloxycarbonyl group include a phenoxycarbonyl group, 2-chlorophenoxycarbonyl group, 4-ethoxyphenoxycarbonyl group, 4-chlorophenoxycarbonyl group, 4-methoxyphenylcarbonyl group, 4-nitrophenoxycarbonyl group, and 3,5-dichlorophenoxycarbonyl group. More preferable examples include a phenoxycarbonyl group, 4-chlorophenoxycarbonyl group, 4-methoxyphenylcarbonyl group, and 4-nitrophenylcarbonyl group. Particularly preferable examples include a phenoxycarbonyl group, 4-methoxyphenylcarbonyl group, and 4-nitrophenoxycarbonyl group.

As the alkoxy group represented by R², an alkoxy group having a total carbon number of 1 to 20 is preferable. The alkoxy group may further have a substituent. As the (substituted) alkoxy group, for example, a methoxy group, ethoxy group, n-propyloxy group, isopropyloxy group, n-butyloxy group, t-butyloxy group, n-hexyloxy group, n-octyloxy group, 2-ethylhexyloxy group, 3,5,5-trimethylhexyloxy group, n-decyloxy group, n-dodecyloxy group, cyclohexyloxy group, benzyloxy group, allyloxy group, 2-methoxyethoxy group, 2-ethoxyethoxy group, 2-phenoxyethoxy group, 2-(2,5-di-t-amylphenoxy)ethoxy group, 2-benzoyloxyethoxy group, methoxycarbonylmethyloxy group, methoxycarbonylethyloxy group, butoxycarbonylethyloxy group, 2-isopropyloxyethyloxy group, isobutyloxy group, phenethyloxy group, dodecylthioxyethyloxy group, naphthoxyethoxy group, 4-methylphenylthioethoxy group, cyanomethoxy group, or trichloromethoxy group is preferable. More preferable examples include a methoxy group, ethoxy group, n-propyloxy group, isopropyloxy group, n-butyloxy group, isobutyloxy group, t-butyloxy group, hexyloxy group, 2-ethylhexyloxy group, octyloxy group, decyloxy group, benzyloxy group, phenethyloxy group, and phenoxyethoxy group. Particularly preferable examples include a methoxy group, ethoxy group, isopropyloxy group, t-butyloxy group, hexyloxy group, 2-ethylhexyloxy group, octyloxy group, decyloxy group, benzyloxy group, phenethyloxy group, and phenoxyethoxy group.

As the aryloxy group represented by R² in formula (1), aryloxy groups having a total carbon number of 6 to 30 are preferable. The aryloxy group may have a substituent or may be unsubstituted. As the (substituted) aryloxy group, for example, a phenyloxy group, 4-methylphenyloxy group, 3-methylphenyloxy group, 2-methylphenyloxy group, 4-chlorophenyloxy group, 2-chlorophenyloxy group, 4-methoxyphenyloxy group, 4-phenoxyphenyloxy group, 4-dodecylthioxyphenyloxy group, or 4-cyanophenyloxy group is preferable. More preferable examples include a phenoxy group, 4-methylphenyloxy group, 3-methylphenyloxy group, 2-methylphenyloxy group, 4-chlorophenyloxy group, 2-chlorophenyloxy group, 4-methoxyphenyloxy group, and 4-phenoxyphenyloxy group. Particularly preferable examples include a phenoxy group, 4-methylphenyloxy group, 4-chlorophenyloxy group, and 4-methoxyphenyloxy group.

As the heterocyclic group represented by R³ and R⁴, a pyridine ring, pyrrole ring, imidazole ring, thiophene ring, thiazole ring, oxazole ring, pyrimidine ring, indole ring or the like is preferable. Among these rings, a pyridine ring is particularly preferable. This heterocyclic group may further have a substituent. When a substituent is introduced into the heterocyclic ring, an alkyl group, nitro group, cyano group, alkoxy group or halogen atom is preferable as the substituent. Among these, an alkoxy group or an alkyl group is particularly preferable.

As the substituent of R¹, a hydrogen atom, an alkyl, aryl and carbamoyl group which may have a substituent are preferable. As the substituent of R², a hydrogen atom, an alkyl, aryl, alkoxy, aryloxy and amino group which may have a substituent are preferable. As the substituent of R³ and R⁴, a hydrogen atom, an alkyl, acyl, and carbamoyl group which may have a substituent are preferable.

<Compounds Represented By Formulae (1-2), (1-3), (1-4) and (1-5)>

The compounds represented by formula (1-2) are subordinate concept of the compounds represented by formula (1). The compounds represented by formulae (1-3), (1-4) and (1-5) are further subordinate concept of the compounds represented by formula (1-2) and specifically indicate more preferable compounds thereof.

Thus, the groups represented by R⁷ and R⁸ in formulae (1-2), (1-3), (1-4) and (1-5), respectively, are the same as defined for R² and R³ in formula (1), and the preferable groups thereof are also the same.

As the alkyl group represented by R⁵ in formulae (1-2) to (1-5), alkyl groups having 1 to 25 carbon atoms are preferable. Examples of such an alkyl group include a methyl group, ethyl group, propyl group, isopropyl group, n-butyl group, sec-butyl group, t-butyl group, pentyl group, hexyl group, heptyl group, n-octyl group, 2-ethylhexyl group, t-octyl group, nonyl group, decyl group, dodecyl group, tridecyl group, tetradecyl group, pentadecyl group, n-hexadecyl group, 2-hexyldecyl group, heptadecyl group, octadecyl group, nonadecyl group, and icosyl group.

The alkyl group may further have a substituent. Examples of the substituent include a phenyl group, halogen atom, alkoxy group, aryloxy group, alkoxycarbonyl group, aryloxycarbonyl group, acyloxy group, acylamino group, carbamoyl group, cyano group, carboxylic acid group, sulfonic acid group and heterocyclic group.

As the (substituted) alkyl group represented by R⁵, in particular, examples include a methyl group, ethyl group, n-propyl group, isopropyl group, n-butyl group, isobutyl group, t-butyl group, n-pentyl group, isopentyl group, cyclopentyl group, hexyl group, cyclohexyl group, heptyl group, octyl group, t-octyl group, 2-ethylhexyl group, decyl group, dodecyl group, octadecyl group, 2-hydroxyethyl group, 2-benzoyloxyethyl group, 2-(4-butoxyphenoxy)ethyl group, benzyl group, allyl group, methoxyethyl group, ethoxyethyl group, dibutylaminocarbonylmethyl group, trichloromethyl group, phenylethyl group, ethoxyethyl group, phenoxyethyl group, methoxycarbonylpropyl group, acetyloxyethyl group, N-butylcarbamoylethyl group, acetylaminoethyl group, 2-cyanobutyl group, and furfuryl group. More preferable examples include a methyl group, ethyl group, n-propyl group, isopropyl group, n-butyl group, isobutyl group, t-butyl group, n-hexyl group, n-octyl group, 2-ethylhexyl group, t-octyl group, and phenylethyl group. Particularly preferable examples include a methyl group, ethyl group, n-propyl group, t-butyl group, and n-hexyl group.

As the aryl group represented by R⁵ in formulae (1-2) to (1-5), aryl groups having 6 to 30 carbon atoms are preferable. Examples of such an aryl group include a phenyl group, naphthyl group, and pyridyl group.

The aryl group may further have a substituent. As the substituent, for example, a phenyl group, halogen atom, alkoxy group, aryloxy group, alkoxycarbonyl group, aryloxycarbonyl group, acyloxy group, acylamino group, carbamoyl group, cyano group, carboxylic acid group, sulfonic acid group, heterocyclic group, alkylthio group, arylthio group, aryloxycarbonyl group, alkoxycarbonylamino group, aryloxycarbonylamino group, carbamoylamino group, amino group or nitro group is preferable.

As the (substituted) aryl group represented by R⁵, in particular, examples include a phenyl group, naphthyl group, 4-chlorophenyl group, 4-methylphenyl group, 4-butoxyphenyl group, 2-methoxyphenyl group, 2-hydroxyphenyl group, 2-hydroxy-5-octylphenyl group, 2,5-diheptyloxyphenyl group, 2-hydroxy-5-butoxyphenyl group, 2-decyloxyphenyl group, 4-methoxyphenyl group, 2-octyloxynaphthyl group, dimethylaminophenyl group, 2-dodecylthiophenyl group, 4-methylphenylthiophenyl group, 2,5-dioctyloxyphenyl group, 2-methoxy-4-dodecylthiophenyl group, 2,5-dibutyloxy-4-nitrophenyl group, 2-phenoxyethoxyphenyl group, 2-dodecyloxyphenyl group, 2-octadecyloxyphenyl group, 2,5-dibenzyloxyphenyl group, 2,5-dicyclohexylmethyloxyphenyl group, 2-methoxy-4-(2-ethylhexanoylamino)phenyl group, 2-butoxy-4-benzoyloxycarbonylamino group, and 2-octyloxy-4-butyloxycarbonylamino group. More preferable examples include a phenyl group, naphtyl group, 2-methoxyphenyl group, 2-decyloxyphenyl group, 4-methoxyphenyl group, 2-octyloxynaphthyl group, dimethylaminophenyl group, 2-dodecylthiophenyl group, 4-(4-methylphenylthioxy)phenyl group, 2-methoxy-4-dodecylthioxyphenyl group, 2-phenoxyethoxyphenyl group, 2-dodecyloxyphenyl group, 2-octadecyloxyphenyl group, 2,5-dibenzyloxyphenyl group, 2,5-dicyclohexylmethyloxyphenyl group, and 2-methoxy-4-(2-ethylhexanoylamino)phenyl group.

As the substituent of R⁶, an alkyl, aryl, alkoxy, aryloxy, alkylthio, arylthio, alkoxycarbonylamino, aryloxycarbonylamino, carbamoylamino, acylamino, alkylsulfonylamino and arylsulfonylamino group which may have a substituent are preferable.

Among these, the alkyl, aryl, alkoxy, aryloxy, acylamino, alkylsulfonylamino and arylsulfonylamino group which may have a substituent are exemplified, and preferable examples thereof are the same as defined for R² in formula (1).

As the alkyl moiety and the aryl moiety of the alkylthio and the arylthio group (corresponding to SR⁹ of formula (1-3)), the aforementioned alkyl group and aryl group are exemplified, and preferable examples thereof are the same as the above listed.

The number of carbons of the alkoxycarbonylamino group represented by R⁶ is preferably 2 to 20. The alkoxycarbonylamino group may further have a substituent. As the substituent, an aryl group, alkoxy group, aryloxy group, alkylthio group, arylthio group, alkoxycarbonyl group, carbamoyl group, or halogen atom is preferable. Examples of the (substituted) alkoxycarbonylamino group include a methoxycarbonylamino group, ethoxycarbonylamino group, n-propyloxycarbonylamino group, n-butyloxycarbonylamino group, isobutyloxycarbonylamino group, n-hexyloxycarbonylamino group, n-octyloxycarbonylamino group, benzyloxycarbonylamino group, 2-ethylhexyloxycarbonylamino group, phenetyloxycarbonylamino group, phenoxyethoxycarbonylamino group, decylthioethoxycarbonylamino group, and ethoxycarbonylmethoxycarbonylamino group. More preferable examples include a methoxycarbonylamino group, ethoxycarbonylamino group, n-propyloxycarbonylamino group, n-butyloxycarbonylamino group, isobutyloxycarbonylamino group, n-hexyloxycarbonylamino group, n-octyloxycarbonylamino group, benzyloxycarbonylamino group, 2-ethylhexyloxycarbonylamino group, and phenethyloxycarbonylamino group. Particularly preferable examples include a methoxycarbonylamino group, ethoxycarbonylamino group, n-propyloxycarbonylamino group, n-buthyloxycarbonylamino group, isobutyloxycarbonylamino group, n-hexyloxycarbonylamino group, n-octyloxycarbonylamino group, benzyloxycarbonylamino group, and 2-ethylhexyloxycarbonyl group.

The number of carbons of the aryloxycarbonylamino group represented by R⁶ is preferably 6 to 30. The aryloxycarbonylamino group may further have a substituent. As the substituent, an alkyl group, alkoxy group, aryloxy group, alkylthio group, alkoxycarbonyl group, carbamoyl group, cyano group, nitro group, or halogen atom is preferable. Examples of the (substituted) aryloxycarbonylamino group include a phenoxycarbonylamino group, naphthoxycarbonylamino group, methylphenoxycarbonylamino group, 4-chlorophenoxycarbonylamino group, 4-nitrophenoxycarbonylamino group, and 4-methoxyphenoxycarbonylamino group. More preferable examples include a phenoxycarbonylamino group, naphthoxycarbonylamino group, methylphenoxycarbonylamino group, 4-chlorophenoxycarbonylamino group, and 4-nitrophenoxylcarbonylamino group. Particularly preferable examples include a phenoxycarbonylamino group, naphtoxycarbonylamino group, and methylphenoxycarbonylamino group.

The number of carbons of the carbamoylamino group represented by R⁶ is preferably 1 to 30. The carbamoylamino group may further have a substituent. As the substituent, an alkyl group or an aryl group is preferable. Examples of the (substituted) carbamoylamino group include an ethylcarbamoylamino group, diethylcarbamoylamino group, dimethylcarbamoylamino group, phenylcarbamoylamino group, dibutylcarbamoylamino group, cyclohexylcarbamoylamino group, 2-ethylhexylcarbamoylamino group, and decylcarbamoylamino group.

When R⁶ has an acylamino group, alkoxycarbamoylamino group, aryloxycarbonylamino group or carbamoylamino group at 5-position, enhanced light fastness and color density at the background area can be obtained.

The compounds represented by formulae (1-3), (1-4) and (1-5) are subordinate concept of the compounds represented by formula (1-2), and preferable positions of the substituents in the formula are thus indicated. Accordingly, exemplary and preferable substituents are the same as those of the compounds represented by formula (1-2).

Specific examples of the compounds represented by formula (1) preferably used in the invention (which include the compounds represented by formulae (1-2) to (1-5)) will be given below: however, these examples are not intended to be limiting of the invention.

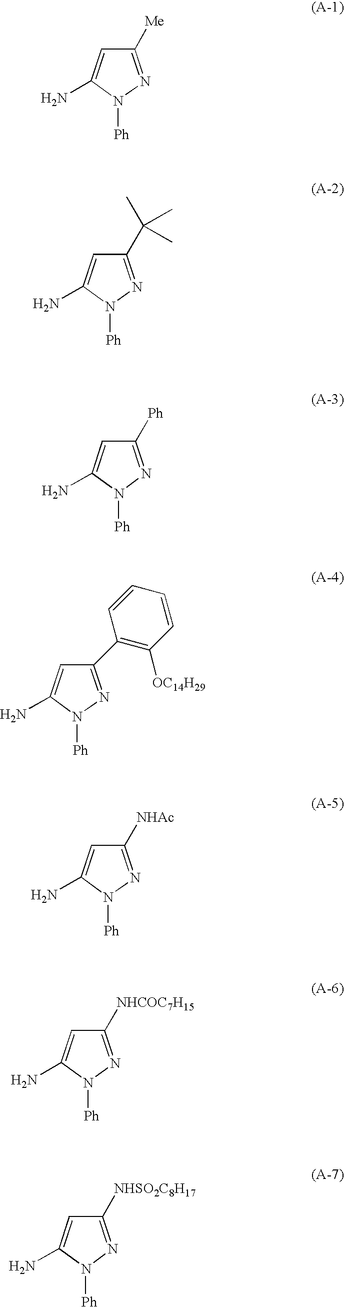

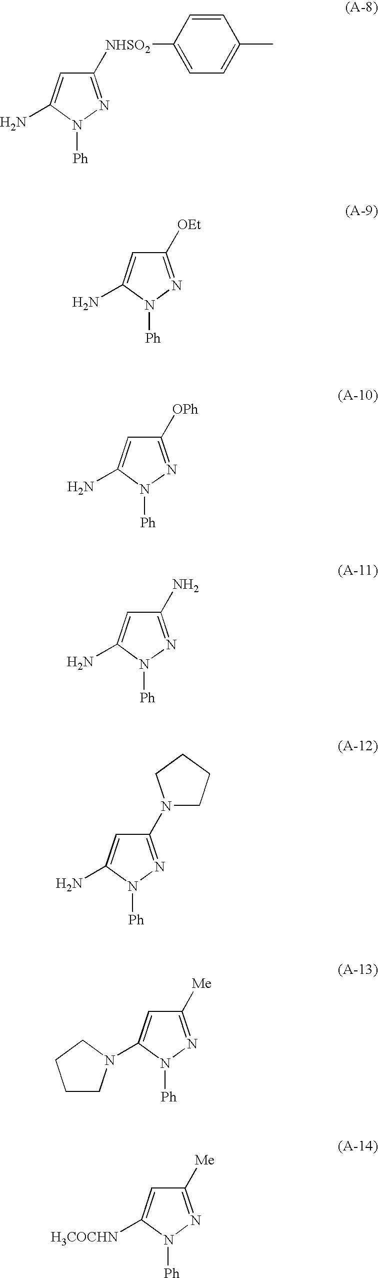

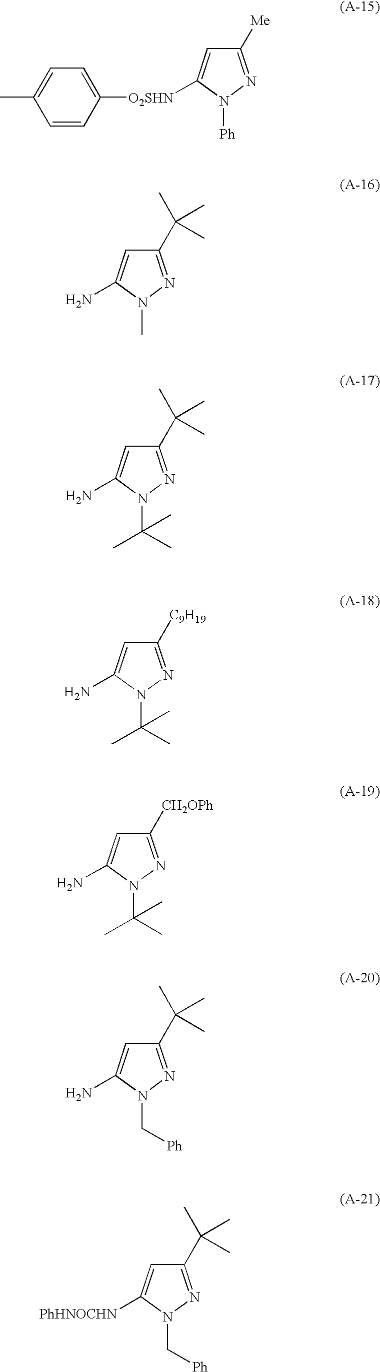

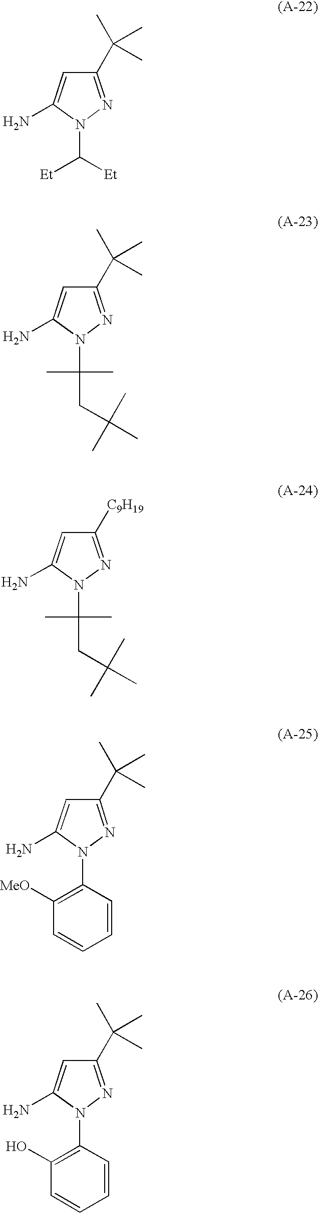

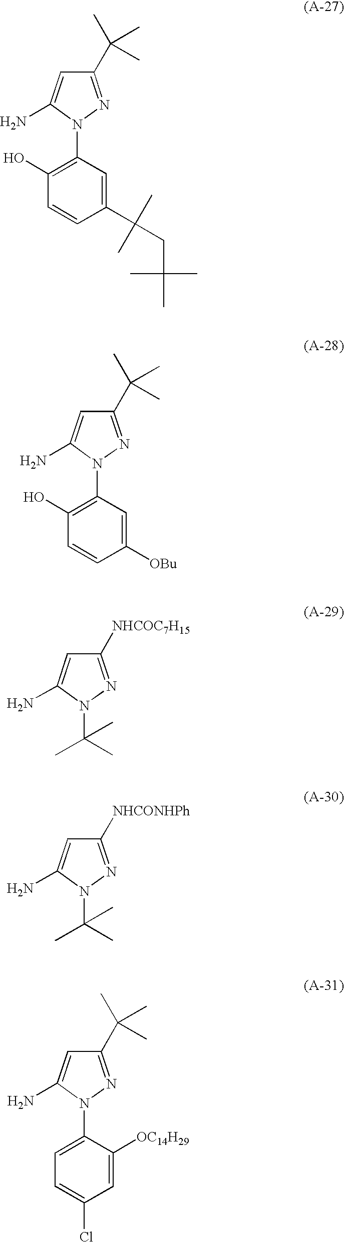

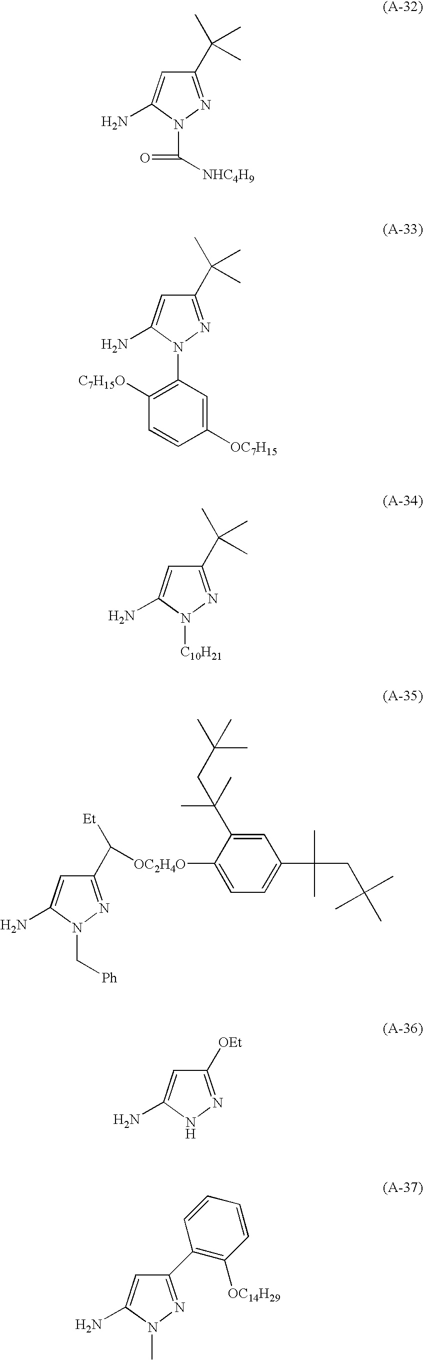

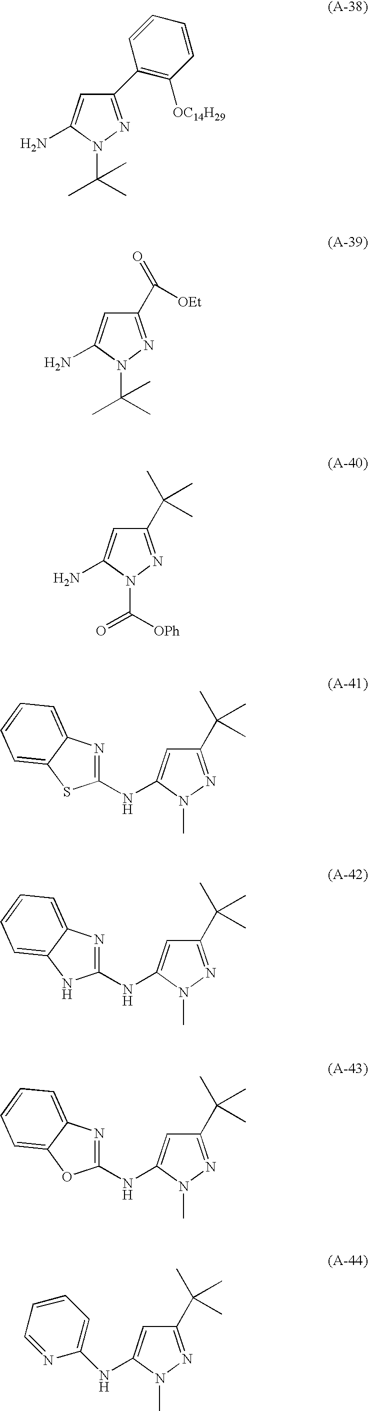

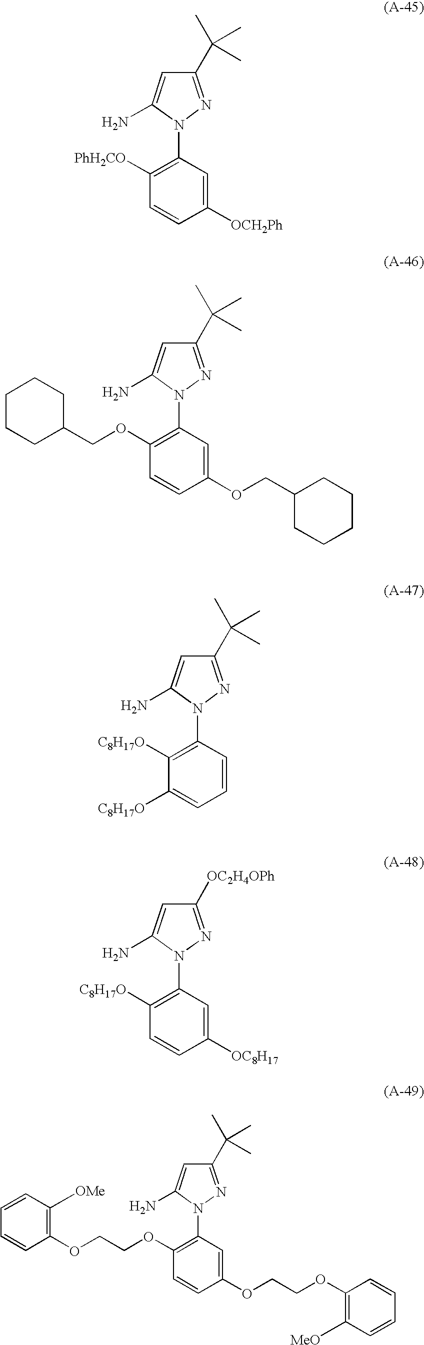

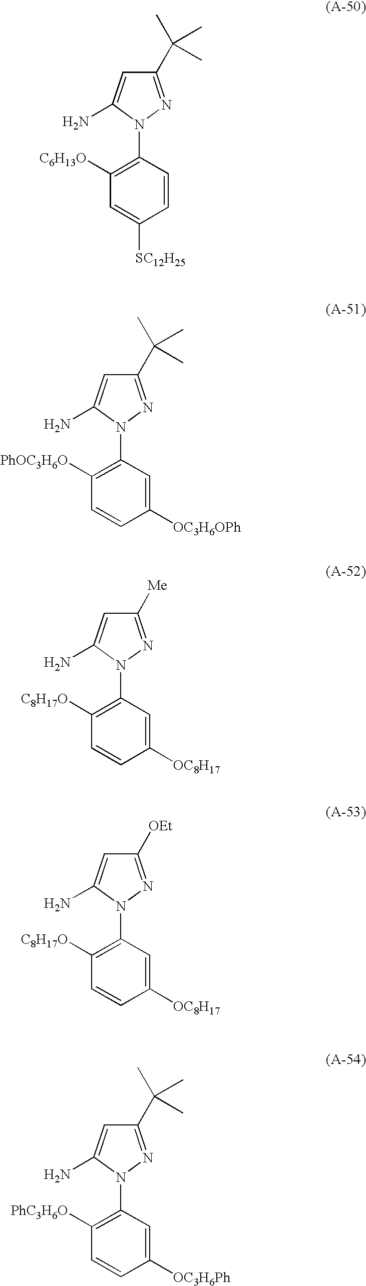

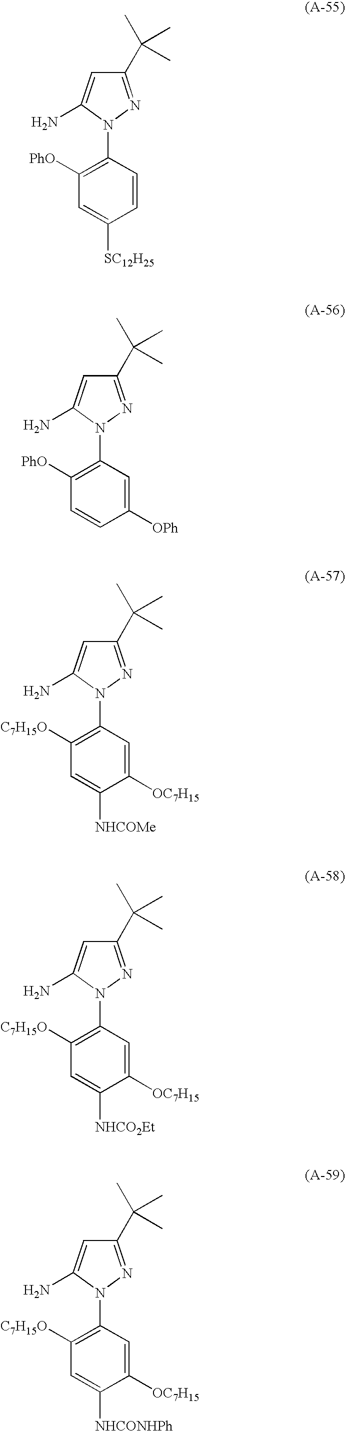

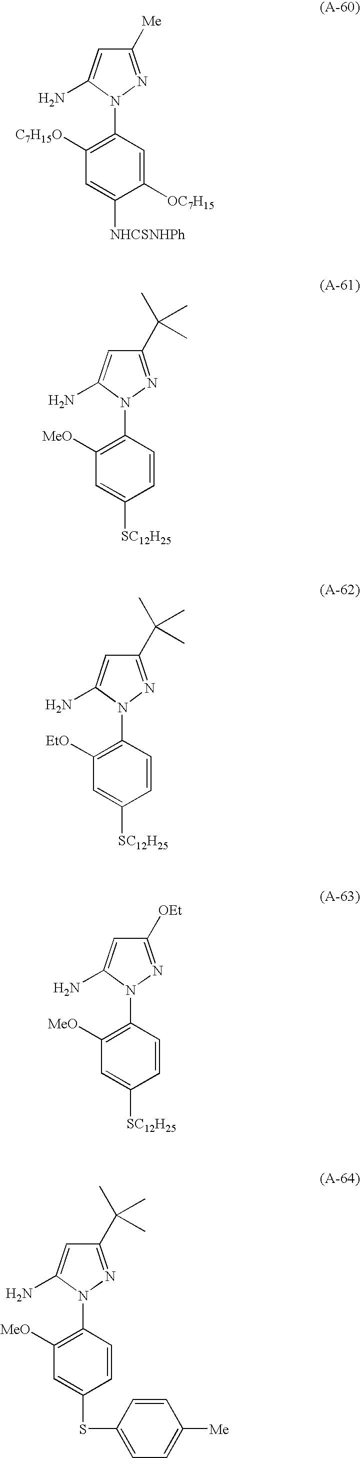

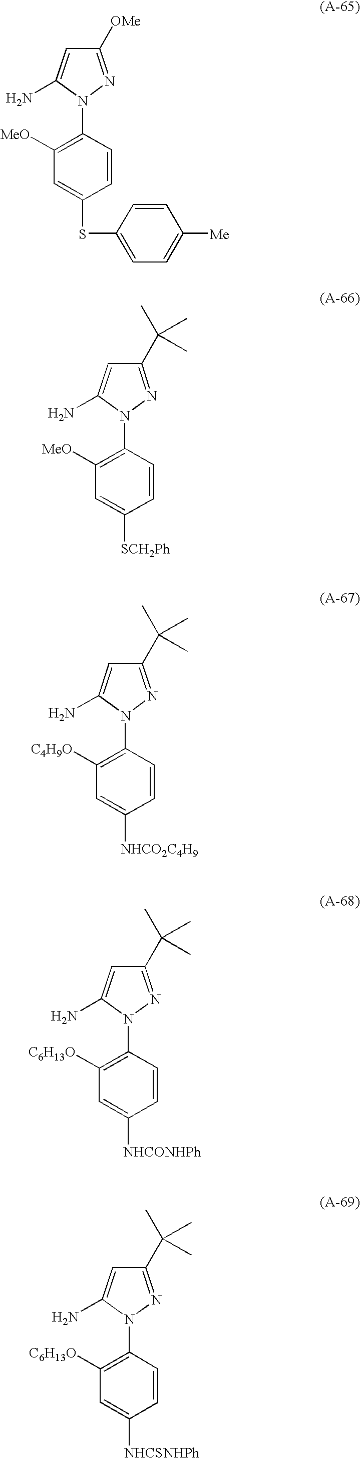

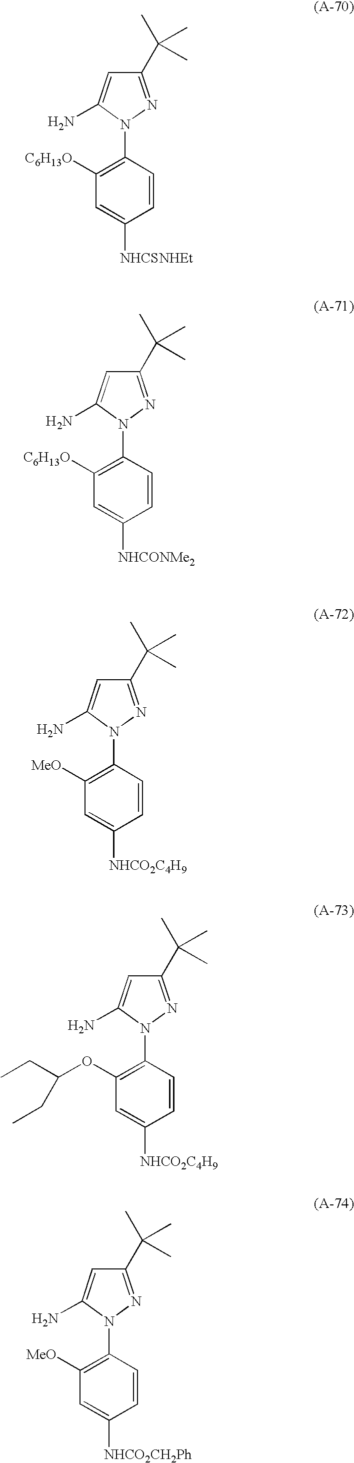

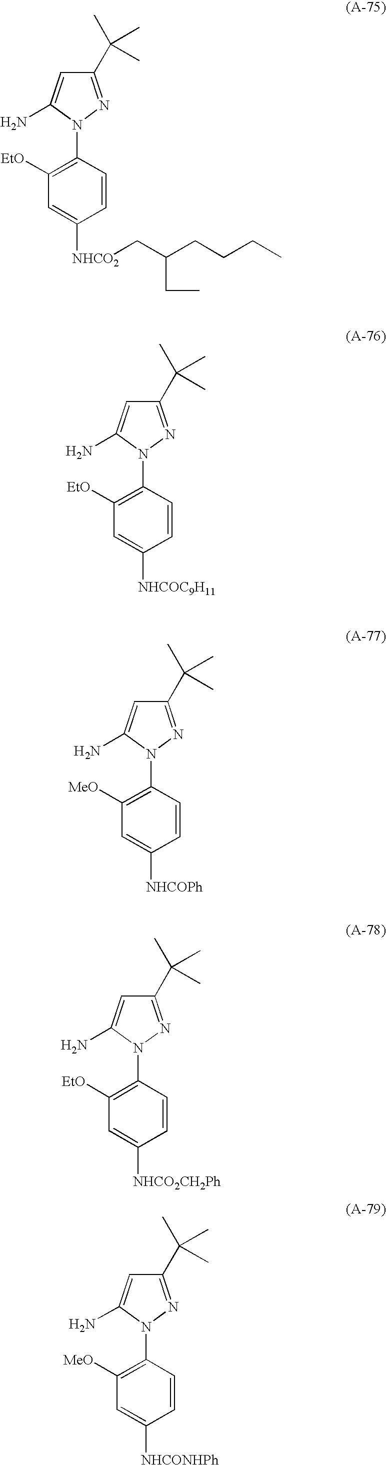

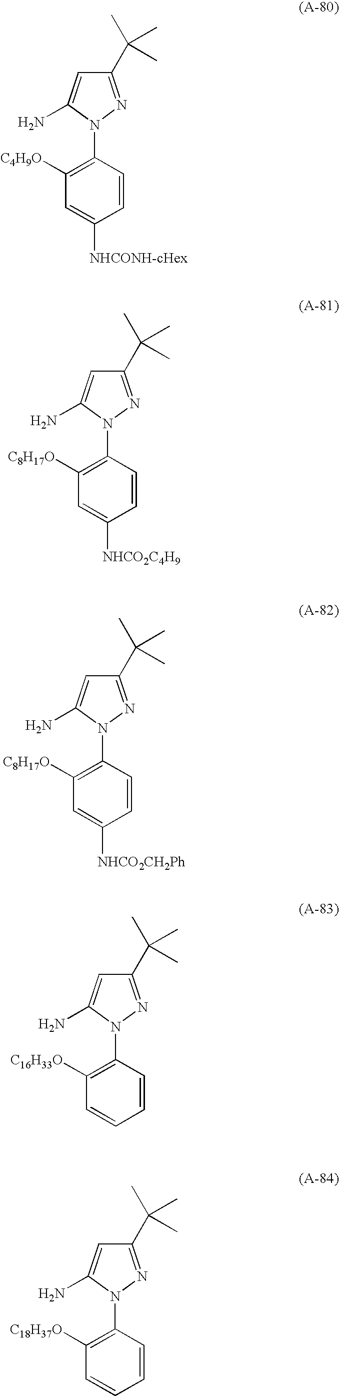

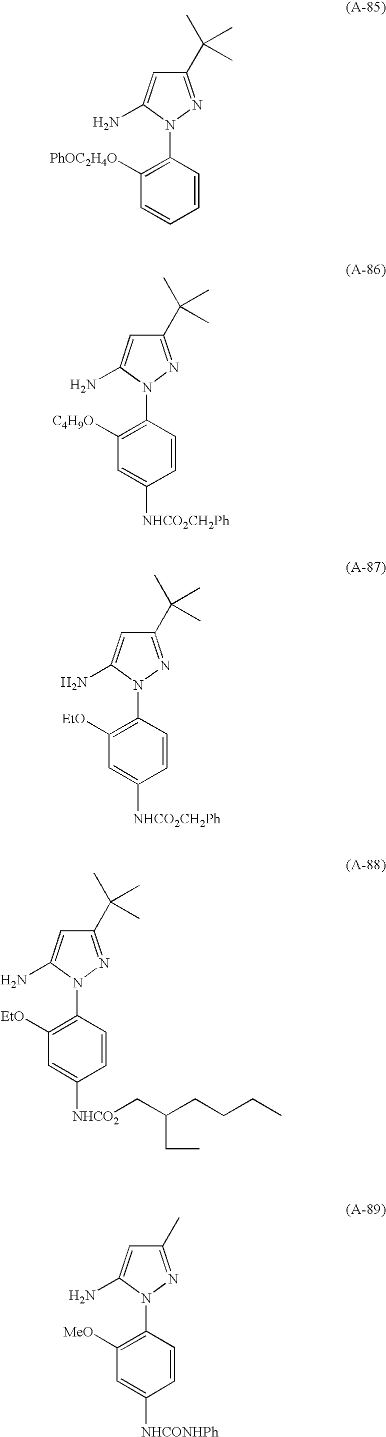

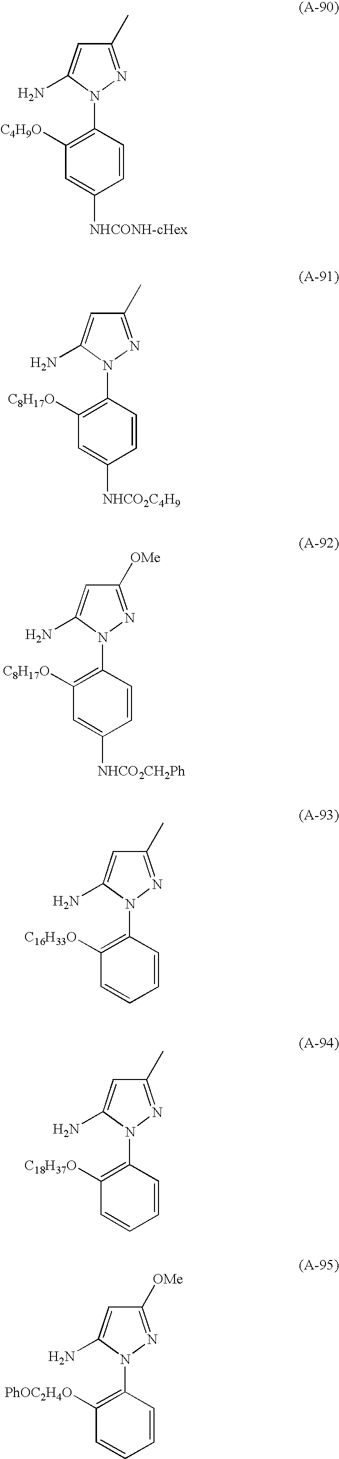

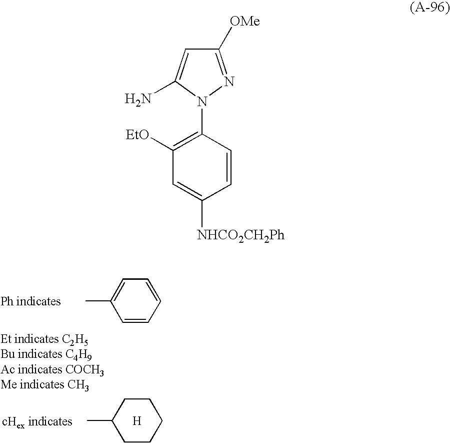

Further, the following compounds A97 to A136 as shown in Table 1 and Table 2 are exemplified.

TABLE 1

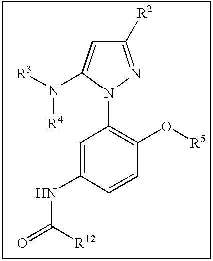

| Compound | R² | R³ | R⁴ | R⁵ | R¹² |
|---|---|---|---|---|---|
| A-97 | t-Bu | H | H | n-Bu | n-C₉H₁₉ |
| A-98 | t-Bu | H | H | n-C₁₂H₂₅ | Me |
| A-99 | t-Bu | H | H | n-C₈H₁₇ | Me |
| A-100 | t-Bu | H | H | Ph | Ph |
| A-101 | t-Bu | H | H | CH₂Ph | Ph |
| A-102 | t-Bu | H | H | n-Bu | NHPh |
| A-103 | t-Bu | H | H | n-Bu | NHPh |
| A-104 | t-Bu | H | H | n-Bu | OPh |
| A-105 | t-Bu | H | H | n-Bu | On—Bu |
| A-106 | t-Bu | H | H | n-Bu | OCH₂Ph |
| A-107 | t-Bu | Et | Et | n-Bu | Me |
| A-108 | t-Bu | Et | H | n-Bu | Me |
| A-109 | t-Bu | Ph | Ph | n-Bu | Me |
| A-110 | t-Bu | Ph | H | n-Bu | Me |
| A-111 | t-Bu | CH₂Ph | H | n-Bu | Me |
| A-112 | t-Bu | Et | H | n-Bu | NHPh |
| A-113 | t-Bu | Et | H | n-Bu | NHEt |
| A-114 | t-Bu | Et | H | n-Bu | OPh |
| A-115 | t-Bu | Et | H | n-Bu | On—Bu |
| A-116 | t-Bu | Et | H | n-Bu | OCH₂Ph |
| A-117 | Me | H | H | n-Bu | n-C₉H₁₉ |
| A-118 | Me | H | H | n-C₁₂H₂₅ | Me |
| A-119 | Me | H | H | n-C₈H₁₇ | Me |
| A-120 | Me | H | H | Ph | Ph |
| A-121 | Me | H | H | CH₂Ph | Ph |
| A-122 | Me | H | H | n-Bu | NHPh |

TABLE 2

| Compound | R² | R³ | R⁴ | R⁵ | R¹² |
|---|---|---|---|---|---|
| A-123 | Me | H | H | n-Bu | NHEt |
| A-124 | Me | H | H | n-Bu | OPh |
| A-125 | Me | H | H | n-Bu | On-Bu |
| A-126 | Me | H | H | n-Bu | OCH₂Ph |
| A-127 | Ph | H | H | n-Bu | Me |
| A-128 | Ph | H | H | Ph | Ph |
| A-129 | Ph | H | H | CH₂Ph | Ph |
| A-130 | Ph | H | H | n-Bu | NHEt |
| A-131 | Ph | H | H | n-Bu | OPh |
| A-132 | H | H | H | n-Bu | Me |
| A-133 | H | H | H | Ph | Ph |
| A-134 | H | H | H | CH₂Ph | Ph |
| A-135 | H | H | H | n-Bu | NHEt |
| A-136 | H | H | H | n-Bu | OPh |

Additionally, the following compounds are exemplified as the coupler compounds of the present invention.

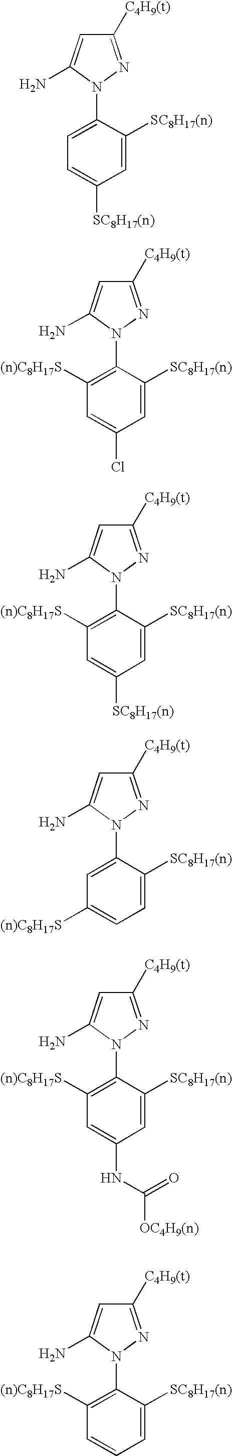

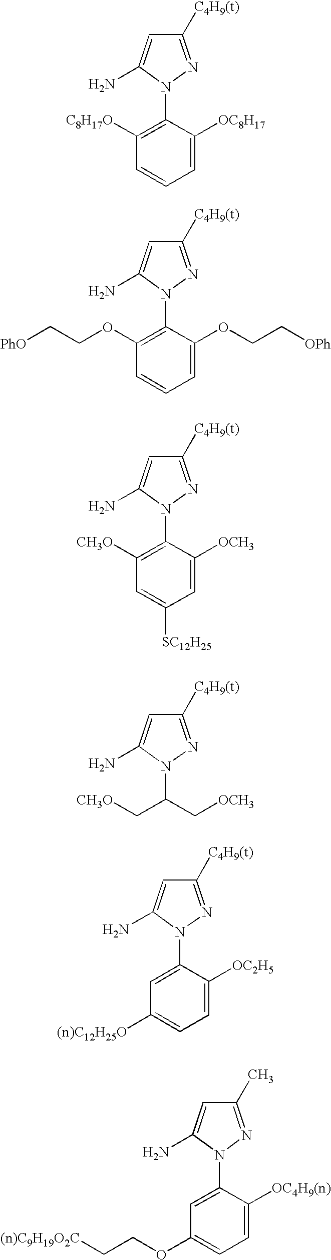

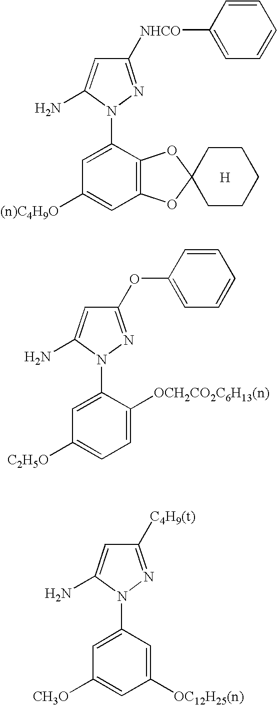

The compounds represented by formula (1) are known compounds and may be synthesized through synthetic methods described in examples of various reports. These compounds may be synthesized using synthetic methods described in, for example, Zh. Obshch. Kim. 1961, 2311, Chem. Ber, 1909, 67 and JP-A Nos. 63-313774, 61-236768 and 4-275277.

Recording Material

The recording material of the invention has the characteristics that it comprises a support having disposed thereon at least one recording layer containing a diazo compound and a coupler, and that the compound represented by formula (1) is used as the coupler. Examples of the recording material of the invention include heat-sensitive recording materials provided with a heat-sensitive recording layer having a color forming system using heat; pressure-sensitive recording materials provided with a pressure sensitive recording layer having a color forming system using pressure and photosensitive; and photothermo-sensitive recording materials that form a latent image by light and develop heat by heating. Description will be given of the recording material of the invention by way of showing, as an example, a recording material (heat-sensitive recording material) provided with a heat-sensitive recording layer, however, the invention is not limited to this recording material.

<Recording Layer>

The recording layer relating to the invention contains at least the compound represented by formula (1) and the diazo compound, and the diazo compound is preferably included in a microcapsule. Also, the recording layer of the invention may contain various additives such as an organic base and a color developing auxiliary, if necessary.

(Coupler)

The compound represented by formula (1) is contained as a coupler in the recording layer used in the invention as mentioned above. The total content of the coupler in the recording layer is preferably 0.2 to 8 mol, and more preferably 0.5 to 4 mol, based on 1 mol of the diazo compound. If the total content of the coupler is less than 0.2 mol based on 1 mol of the diazo compound, there is the case where only insufficient developed color is obtained. If the total content of the coupler exceeds 8 mol based on 1 mol of the diazo compound, there is the case where coatability is impaired.

Also, in the invention, a known coupler that causes coupling with the diazo compound in a basic atmosphere to thereby form a dye may be used in combination with the compound represented by formula (1), if necessary, for the purpose of regulating a hue. In the case of using the compound represented by formula (1) together with a known coupler, the compound represented by formula (1) is contained in an amount of preferably 50% by mass or more, and more preferably 70% by mass, of the total coupler contained in the recording layer.

Examples of the aforementioned known coupler include so-called active methylene compounds having a methylene group adjacent to a carbonyl group, phenol derivatives and naphthol derivatives.

Specific examples of the aforementioned known coupler include resorcin, fluoroglucin, sodium 2,3-dihydroxynaphthalene-6-sulfonate, 1-hydroxy-2-naphthoenic acid morpholinopropylamide, 1,5-dihydroxynaphthalene, 2,3-dihydroxynaphthalene, 2,3-dihydroxy-6-sulfo-naphthalene, 2-hydroxy-3-naphthoenic acid morpholinopropylamide, 2-hydroxy-3-naphthoenic acid octylamide, 2-hydroxy-3-naphthoenic acid anilide, benzoylacetanilide, 1-phenyl-3-methyl-5-pyrazolone, 1-(2,4,6-trichlorophenyl)-3-anilino-5-pyrazolone, 2-{3-[α-(2,4-di-tert-amylphenoxy)butaneamido]benzamido}phenol, 2,4-bis-(benzoylacetamino)toluene and 1,3-bis-(pivaloylacetaminomethyl)benzene.

(Diazo Compound)

Although no particular limitation is imposed on the diazo compound used for the recording layer in the invention, it is preferable to use diazo compounds represented by the following formula (2).

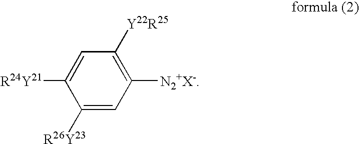

In formula (2), R²⁴ and R²⁶ each independently represent an alkyl, aryl, heterocyclic or acyl group which may have a substituent. R²⁵ represents an alkyl, aryl, alkylsulfonyl, arylsulfonyl, acyl or heterocyclic group which may have a substituent. Y²¹ represents an oxygen atom, a sulfur atom or a nitrogen atom, Y²² represents an oxygen atom, a sulfur atom or a single bond, and Y²³ represents an oxygen atom, a sulfur atom or a hydrogen atom. However, R²⁶ is not present when Y²³ is a hydrogen atom. R²⁴ and R²⁶ may be bonded to each other to form a ring. X⁻ represents an anion.

As R²⁴ and R²⁶ in formula (2), an alkyl group having 1 to 30 carbon atoms, an aryl group having 6 to 30 carbon atoms or an acyl group having 2 to 20 carbon atoms is preferable.

The alkyl group represented by R²⁴ and R²⁶ may further have a substituent. As the substituent, for example, a phenyl group, halogen atom, alkoxy group, aryloxy group, alkoxycarbonyl group, acyloxy group, acylamino group, carbamoyl group, cyano group, carboxylic acid group, sulfonic acid group or heterocyclic group is preferable.

As the (substituted)alkyl group represented by R²⁴ and R²⁶, a methyl group, ethyl group, n-propyl group, iso-propyl group, n-butyl group, iso-butyl group, pentyl group, 3-pentyl group, cyclopentyl group, hexyl group, cyclohexyl group, heptyl group, octyl group, 2-ethylhexyl group, decyl group, dodecyl group, octadecyl group, 2-hydroxyethyl group, 2-benzoyloxyethyl group, 2-(4-butoxyphenoxy)ethyl group, benzyl group, aryl group, methoxyethyl group, ethoxyethyl group or dibutylaminocarbonylmethyl group is preferable.

The aryl group represented by R²⁴ and R²⁶ may further have a substituent. As the substituent, for example, a phenyl group, halogen atom, alkoxy group, aryloxy group, alkoxycarbonyl group, acyloxy group, acylamino group, carbamoyl group, cyano group, carboxylic acid group, sulfonic acid group or heterocyclic group is preferable.

As the (substituted) aryl group represented by R²⁴ and R²⁶, particularly, a phenyl group, 4-methoxyphenyl group, 4-chlorophenyl group, 4-methylphenyl group, 4-butoxyphenyl group or naphthyl group is preferable.

When R²⁴ and R²⁶ are a heterocyclic group, the hetero ring is preferably those having nitrogen, oxygen or sulfur as a hetero atom and may be any of a saturated, unsaturated, monocyclic or condensed ring. Specific examples of the heterocyclic ring include furyl, thienyl, oxazolyl, atazolyl, imidazolyl, pyrazolyl, pyridyl, pyrimidyl, morpholinyl, piperazinyl, indolyl and isoindolyl. Further, these hetrocyclic groups may have a substituent. Examples of the substituent include the same groups as those given as the aforementioned alkyl group.

The acyl group represented by R²⁴ and R²⁶ may be any of aliphatic groups, aromatic groups and heterocyclic groups and may further have a substituent. As the substituent, an alkoxy group, aryloxy group, halogen atom or the like is preferable.

As the acyl group represented by R²⁴ and R²⁶, an acetyl group, propanoyl group, hexanoyl group, benzoyl group or the like is preferable.

Also, R²⁴ and R²⁶ may be bonded to each other to form a ring. Examples of the ring obtained by bonding R²⁴ with R²⁶ include a thiazole ring, oxazole ring and imidazole ring, which may further have a substituent. Examples of the substituent include the same groups as those given as the aforementioned alkyl group.

As R²⁵ in formula (2), an alkyl group having 1 to 20 carbon atoms, an aryl group having 6 to 20 carbon atoms or an acyl group having 2 to 20 carbon atoms is preferable.

Examples of the alkyl group, aryl group, heterocyclic group and acyl group in R²⁵ include the same groups as those given as the alkyl group, aryl group, heterocyclic group and acyl group respectively in R²⁴ and R²⁶.

The alkylsulfonyl group represented by R²⁵ may have a substituent. As the substituent, for example, a phenyl group, halogen atom, alkoxy group, aryloxy group, alkoxycarbonyl group, acyloxy group, acylamino group, carbamoyl group, cyano group, carboxylic acid group, sulfonic acid group or heterocyclic group is preferable.

Examples of the (substituted)alkylsulfonyl group represented by R²⁵ include a methylsulfonyl group, ethylsulfonyl group, butylsulfonyl group, hexylsulfonyl group, decylsulfonyl group, benzylsulfonyl group and methoxybutylsulfonyl group.

The arylsulfonyl group represented by R²⁵ may further have a substituent. As the substituent, for example, a phenyl group, halogen atom, alkoxy group, aryloxy group, alkoxycarbonyl group, acyloxy group, acylamino group, carbamoyl group, cyano group, carboxylic acid group, sulfonic acid group or heterocyclic group is preferable.

Particularly preferable examples of the (substituted) arylsulfonyl group represented by R²⁵ include a phenylsulfonyl group, naphthylsulfonyl group, 4-chlorobenzenesulfonyl group and 4-methylbenzenesulfonyl group.

As Y²¹ in formula (2), a sulfur atom or an amino group is preferable. When Y²¹ is an amino group, it may have a substituent. Examples of the substituent include an alkyl group and aryl group.

Also, Y²¹ and R²⁴ may form a ring. Examples of the ring formed by Y²¹ and R²⁴ include pyrrolidinyl, piperidinyl, piperazinyl and indolyl. These groups may further have a substituent. Examples of the substituent include the same groups as those given as the aforementioned alkyl group.

As Y²² in formula (2), a sulfur atom or oxygen atom is preferable. Similarly, as Y²³, a sulfur atom or oxygen atom is preferable.

Examples of the anion represented by X⁻ in formula (2) include inorganic anions and organic anions. As the inorganic anion, a hexafluorophosphoric acid ion, boron hydrofluoric acid ion, chloride ion or sulfuric acid ion is preferable, and a hexafluorophosphoric acid ion or boron hydrofluoric acid ion is particularly preferable. As the organic anion, a polyfluoroalkylcarboxylic acid ion, polyfluoroalkylsulfonic acid ion, tetraphenylboric acid ion, aromatic carboxylic acid ion or aromatic sulfonic acid ion is particularly preferable.

The diazonium salt represented by formula (2) is preferably a diazonium salt represented by formula (3) or (4).

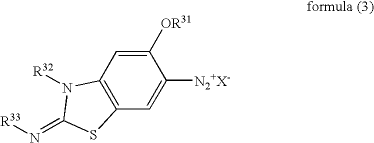

In formula (3) shown above, R³¹ and R³² each independently represent an alkyl or aryl group which may have a substituent; R³³ indicates a hydrogen atom or an alkyl or aryl group which may have a substituent; and X⁻ represents an anion.

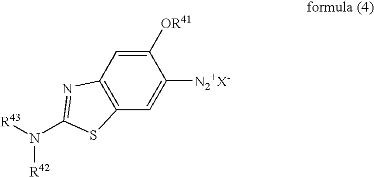

In formula (4) shown above, R⁴, R⁴² and R⁴³ each independently represent an alkyl or aryl group which may have a substituent, or R⁴² and R⁴³ may be bonded to each other to form a ring; and X⁻ represents an anion.

As R³′, R³² and R³³ in formula (3), an alkyl group having 1 to 20 carbon atoms or an aryl group having 6 to 30 carbon atoms is preferable.

The alkyl group represented by R³¹, R³² and R³³ may further have a substituent. As the substituent, for example, a phenyl group, halogen atom, alkoxy group, aryloxy group, alkoxycarbonyl group, acyloxy group, acylamino group, carbamoyl group, cyano group, carboxylic acid group, sulfonic acid group or heterocyclic group is preferable.

As the (substituted) alkyl group represented by R³¹, R³² and R³³, a methyl group, ethyl group, n-propyl group, iso-propyl group, n-butyl group, iso-butyl group, pentyl group, cyclopentyl group, hexyl group, cyclohexyl group, heptyl group, octyl group, 2-ethylhexyl group, decyl group, dodecyl group, octadecyl group, 2-hydroxyethyl group, 2-benzoyloxyethyl group, 2-(4-butoxyphenoxy)ethyl group, benzyl group, aryl group, methoxyethyl group, ethoxyethyl group or dibutylaminocarbonylmethyl group is preferable.

The aryl group represented by R³¹, R³² and R³³ in formula (3) may further have a substituent. As the substituent, for example, a phenyl group, halogen atom, alkoxy group, aryloxy group, alkoxycarbonyl group, acyloxy group, acylamino group, carbamoyl group, cyano group, carboxylic acid group, sulfonic acid group or heterocyclic group is preferable.

As the (substituted) aryl group represented by R³¹, R³² and R³³, particularly, a phenyl group, 4-chlorophenyl group, 4-methylphenyl group or 4-butoxyphenyl group is preferable.

X⁻ in formula (3) is the same as X⁻ defined in formula (2), and the same examples given as X⁻ in formula (2) are also given as X⁻ in formula (3).

Preferable examples of the alkyl group, aryl group and X⁻ represented by R⁴¹, R⁴² and R⁴³ in formula (4) include the same groups as those given as the examples of the alkyl group, aryl group and X⁻ each independently represented by R³¹ to R³³ in formula (3). Also, R⁴² and R⁴³ may be bonded to each other to form a ring. Examples of the ring formed by R¹² and R¹³ include a morpholine ring, piperidine ring and pyrrolidine ring.

Specific examples (exemplary compounds (D-1) to (D-92)) of the diazonium salt compound represented by formulae (2) to (4) will be shown below: however, these examples are not intended to be limiting of the invention.

Diazonium salts represented by Formula (2)

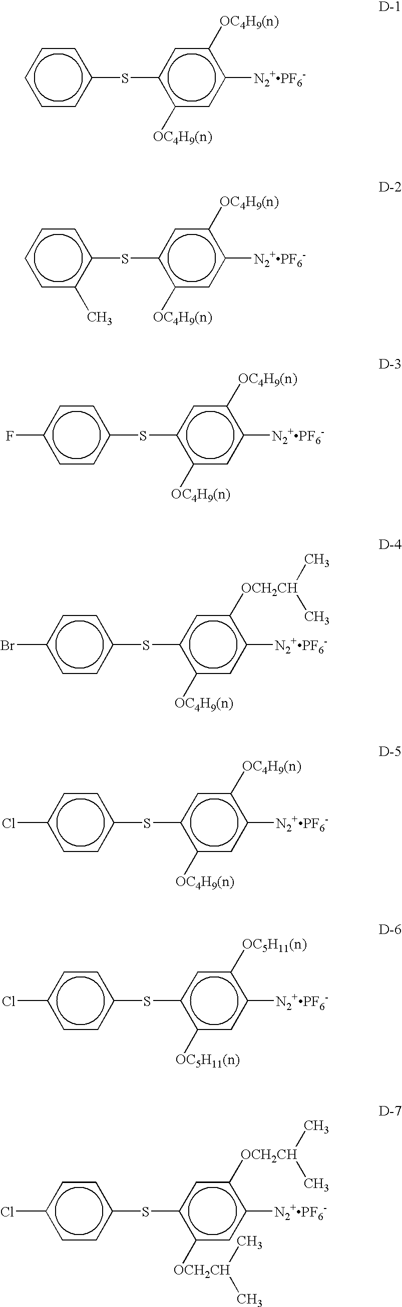

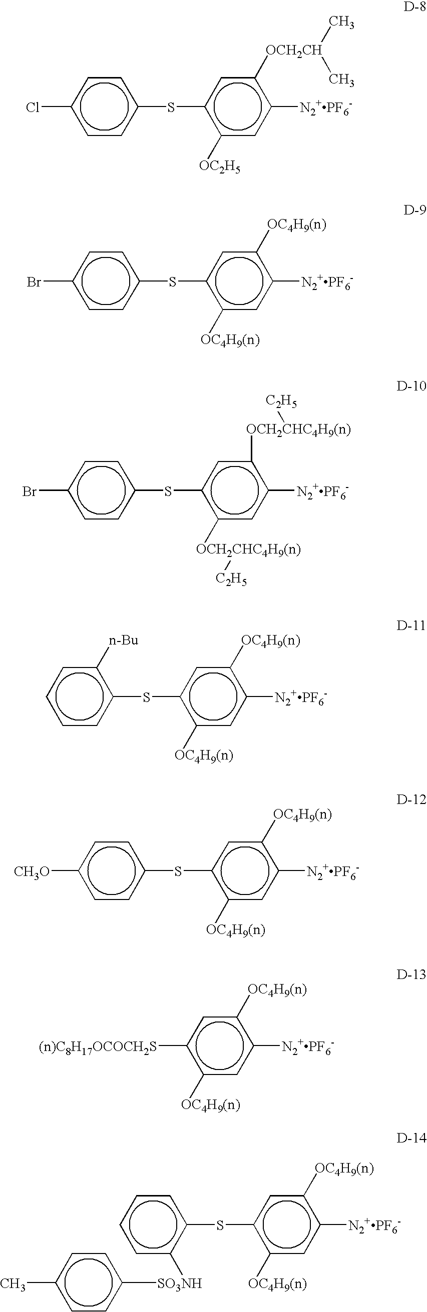

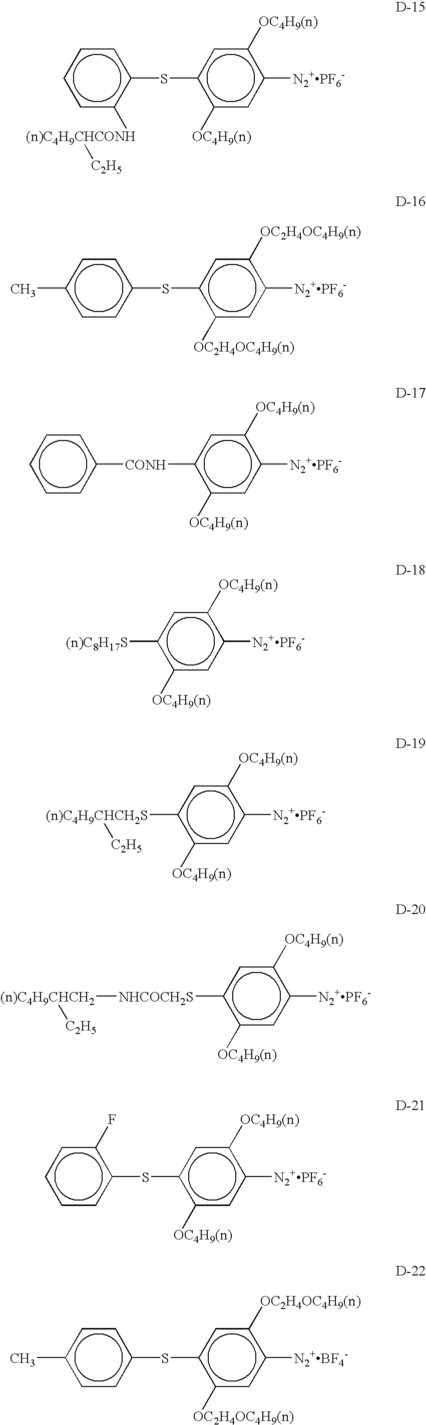

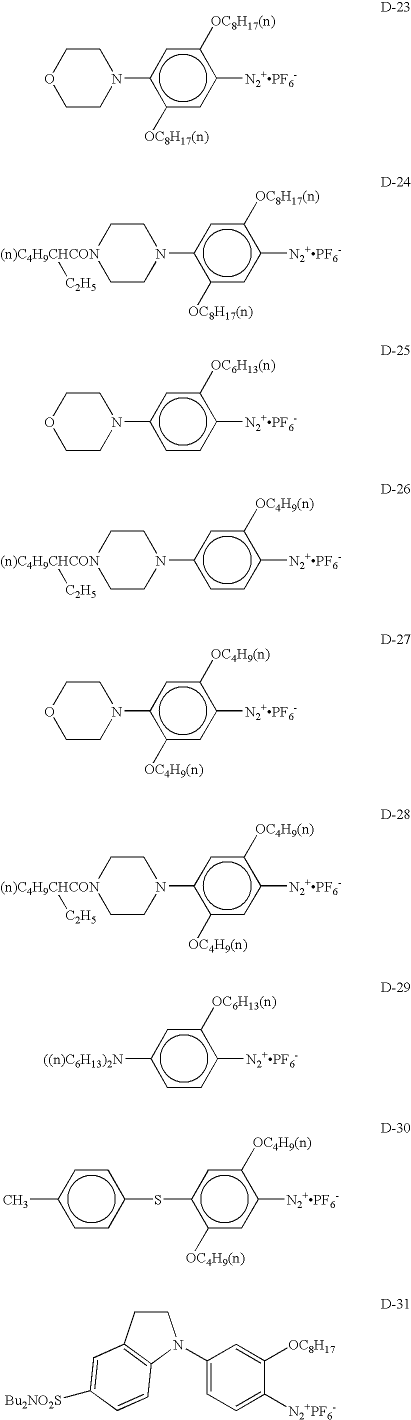

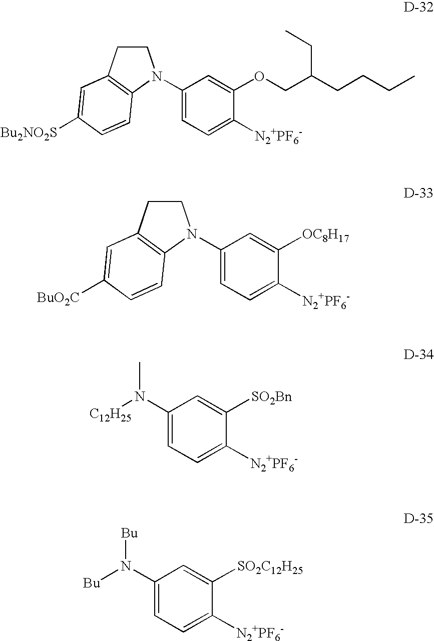

Diazonium salts represented by Formula (3):

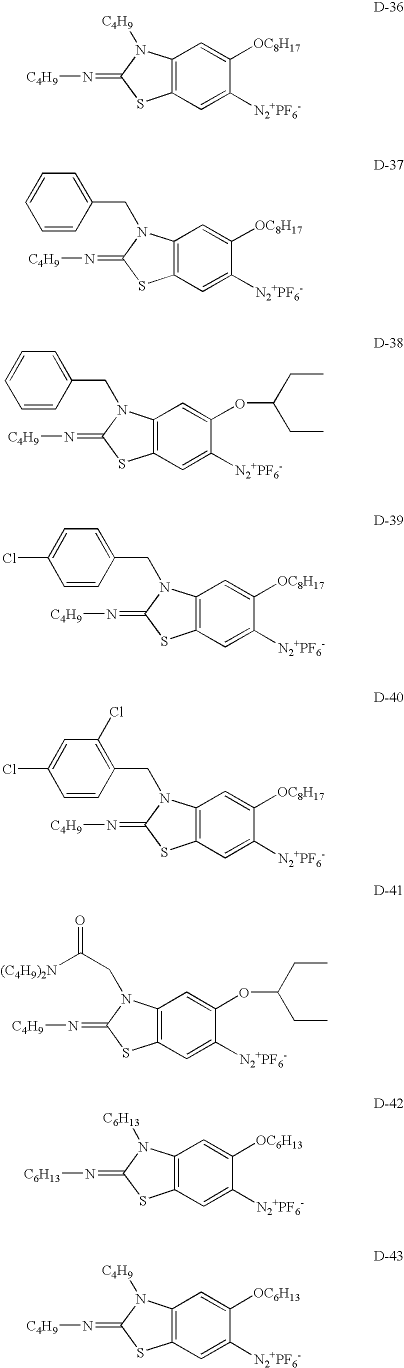

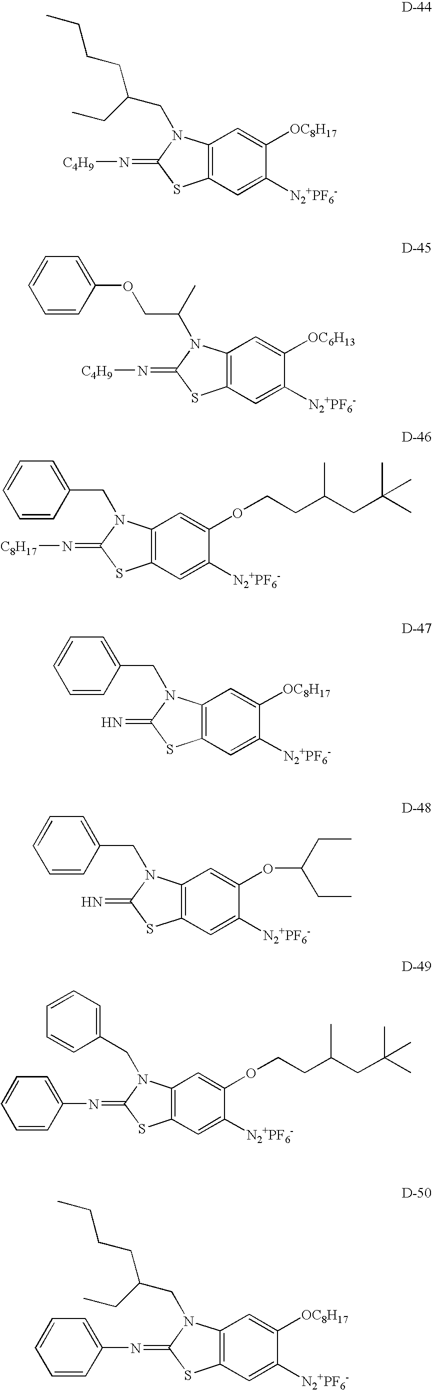

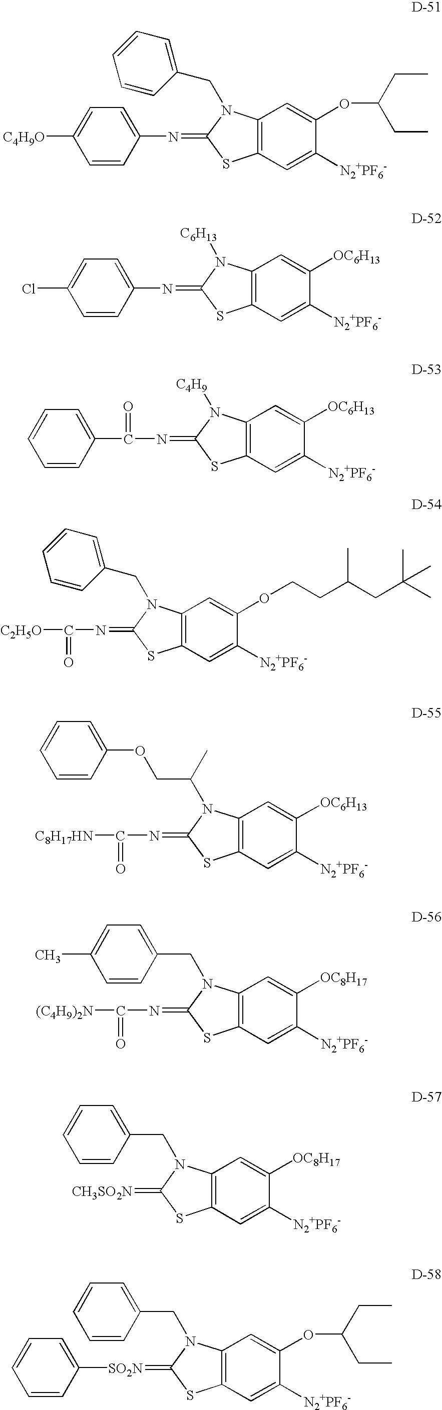

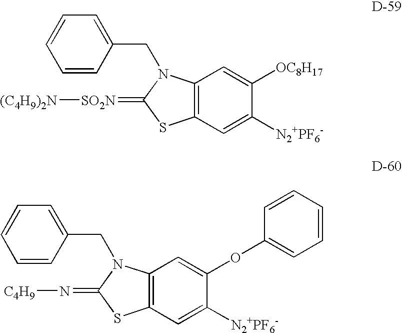

Diazonium salts represented by Formula (4):

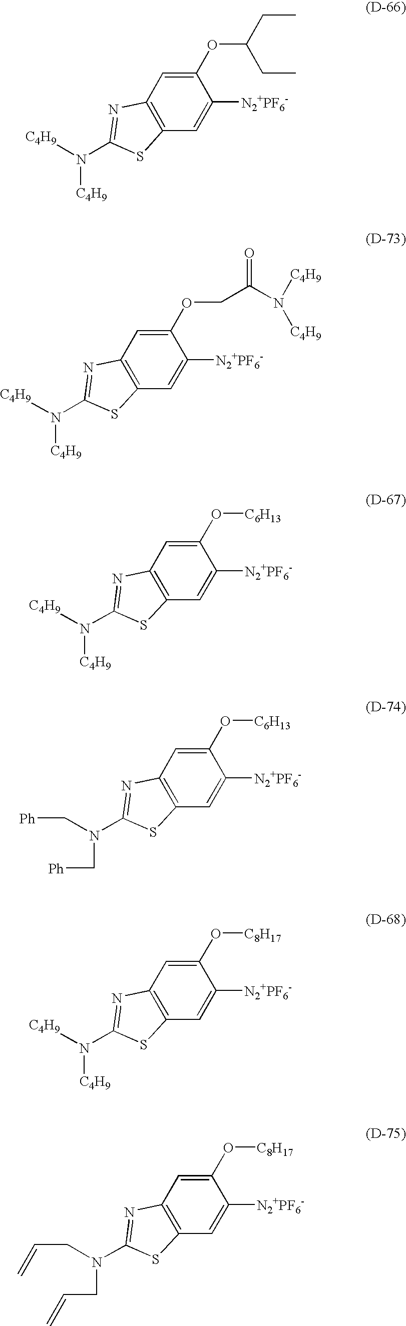

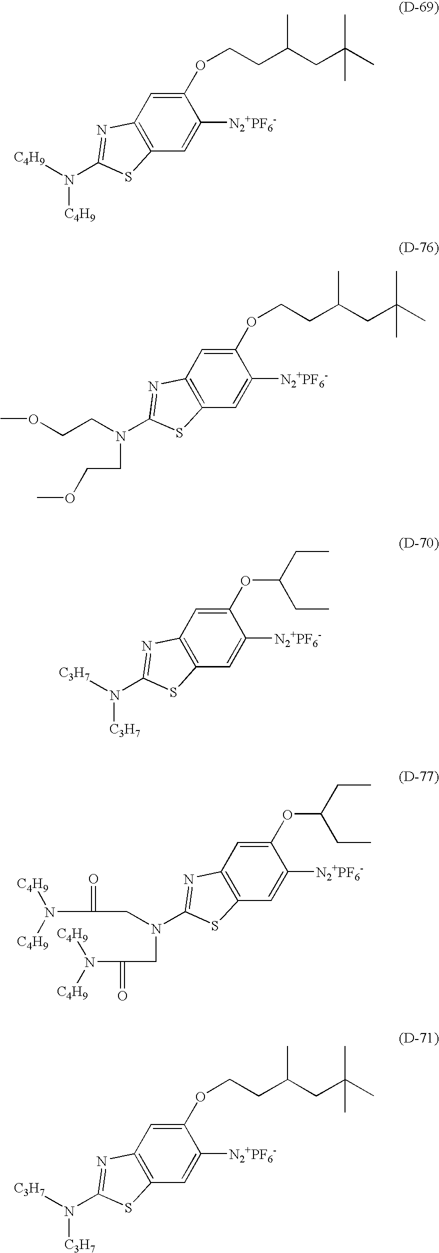

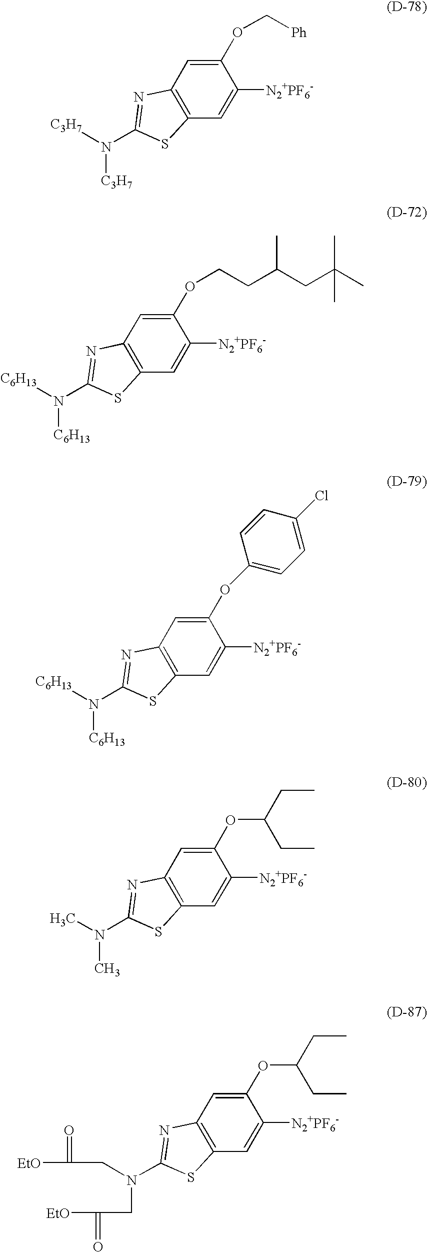

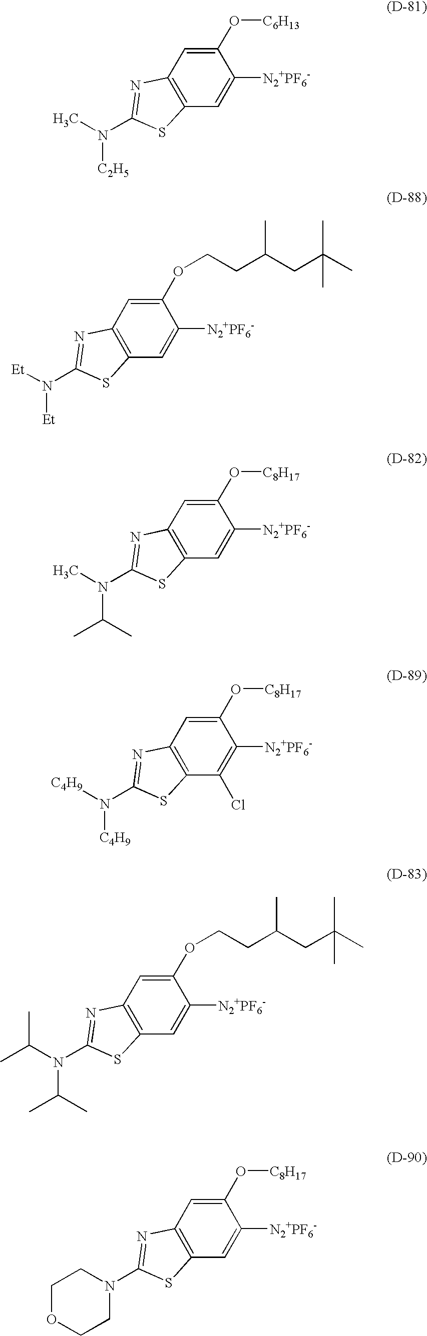

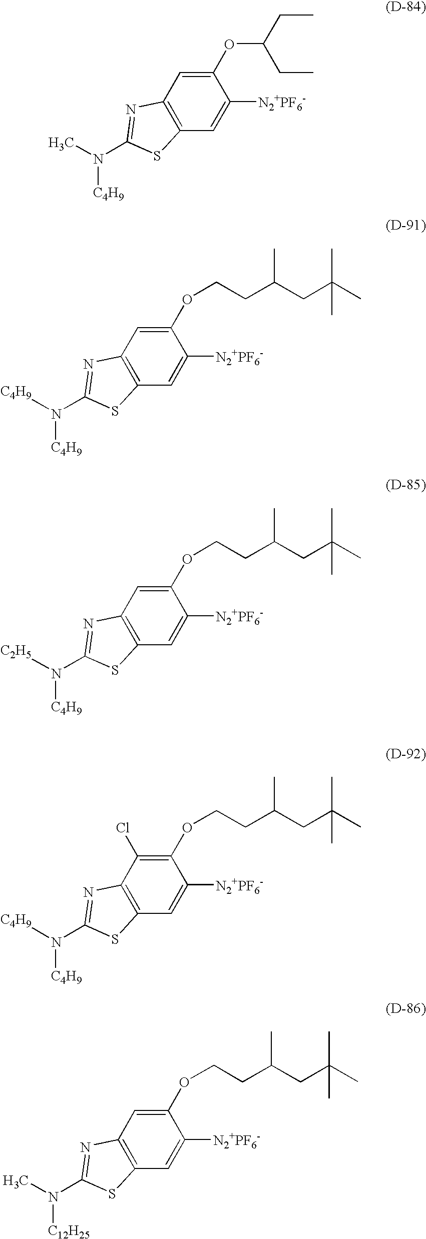

The diazonium salt represented by formulae (2) to (4) may be used either singly or in combination of two or more. It is possible to combine the diazonium salt represented by each of formulae (2) to (4) with a known diazonium salt, corresponding to various purposes such as hue regulation. In the case of combining the diazonium salt represented by each of formulae (2) to (4) with a known diazonium salt, the amount of the diazonium salt represented by each of formulae (2) to (4) is preferably 50% by mass or more, and more preferably 80% by mass or more, of all diazonium salts contained in the recording layer.

The known diazonium salt is preferably 4-diazo-1-dimethylaminobenzene, 4-diazo-2-butoxy-5-chloro-1-dimethylaminobenzene, 4-diazo-1-methylbenzylaminobenzene, 4-diazo-1-ethylhydroxyethylaminobenzene, 4-diazo-1-diethylamino-3-methoxybenzene, 4-diazo-1-morpholinobenzene, 4-diazo-1-morpholino-2,5-dibutoxybenzene, 4-diazo-1-tolylmercapto-2,5-diethoxybenzene, 4-diazo-1-piperazino-2-methoxy-5-chlorobenzene, 4-diazo-1-(N,N-dioctylaminocarbonyl)benzene, 4-diazo-1-(4-tert-octylphenoxy)benzene, 4-diazo-1-(2-ethylhexanoylpiperidino)-2,5-dibutoxybenzene, 4-diazo-1-[α-(2,4-ditert-amylphenoxy)butyrylpiperidino]benzene, 4-diazo-1-(4-methoxy)phenylthio-2,5-diethoxybenzene, 4-diazo-1-(4-methoxy)benzamido-2,5-diethoxybenzene and 4-diazo-1-pyrrolidino-2-methoxybenzene.

Further, in the recording material of the invention, the diazonium salt is preferably included in a microcapsule, as detailed later, to improve pre-use raw stock storability of the recording material. Since the diazonium salt is dissolved in a proper solvent upon use, the diazonium salt preferably exhibits proper solubility in these solvents and low water-solubility. Specifically, the diazonium salt preferably has a solubility of 5% or more in an organic solvent used and a solubility of 1% or less in water.

In the recording material of the invention, the diazonium salt is preferably contained in an amount ranging from 0.02 to 3 g/m², and particularly from 0.1 to 2 g/m², in the recording layer from the viewpoint of developed color density.

(Microcapsule)

It is preferable that in the recording material of the invention, the diazo compound is included in a microcapsule to improve raw stock storability before the recording material is used.

The microcapsule for use in this case is produced in the following manner. Specifically, a solution obtained by dissolving the diazo compound and compounds of the same or different types which react with each other to form a polymer material in a nonaqueous solvent having a boiling point of 40 to 95° C. under normal pressure is emulsified and dispersed in a hydrophilic protective colloid solution. Then, a wall-forming material is made to migrate to the surface of oil droplets, while the temperature of the solution is raised with reducing the pressure in a reaction container to evaporate off a solvent, and a polymer producing reaction by polymerization addition or polymerization condensation is allowed to progress on the surface of oil droplets to thereby form a wall film.

In the recording material of the invention, it is preferable to use, in particular, a microcapsule that does not substantially contain a solvent, to be described later, from the viewpoint of obtaining a good shelf life. Also, the polymer material that forms the microcapsule wall is preferably at least one selected from polyurethane and polyurea.

A method of producing a diazo compound-containing microcapsule (polyurea/polyurethane wall) in the recording material of the invention will be explained hereinafter.

First, the above diazo compound is dissolved in a hydrophobic organic solvent which becomes a core of the capsule. As the hydrophobic organic solvent used in this case, an organic solvent having a boiling point of 100 to 300° C. is preferable. Examples of the organic solvent include aromatic hydrocarbons, halogenated hydrocarbons, carboxylates, phosphates, sulfates, sulfonates, ketones and ethers. Specific examples of the organic solvent include an alkylnaphthalene, alkyldiphenylethane, alkyldiphenylmethane, alkylbiphenyl, paraffin chloride, trixylyl phosphate, tricresyl phosphate, dioctyl maleate and dibutyl adipate. These solvents may be used either alone or in combination of two or more.

In the case where solubility of the diazo compound, to be encapsulated, in the above organic solvent is low, a low-boiling point solvent in which the diazo compound is highly soluble may be used together. Specific examples of the low-boiling point solvent include ethyl acetate, butyl acetate, methylene chloride, tetrahydrofuran and acetone. Also, a polyvalent isocyanate is added as a wall material in the hydrophobic organic solvent which becomes the core of the microcapsule (oil phase).

On the other hand, an aqueous solution in which a water-soluble polymer such as a polyvinyl alcohol or gelatin was dissolved is prepared as a water phase. Then, the above oil phase is poured into the water-phase and the mixture of both phases is emulsified and dispersed by means of a homogenizer. At this time, the water-soluble polymer acts as a stabilizer for emulsifying dispersion. In order to carry out emulsifying dispersion more stably, a surfactant may be added to at least one of the oil and water phases.

The amount of the polyvalent isocyanate to be used is controlled such that the microcapsule has an average particle diameter of 0.3 to 12 μm and a wall thickness of 0.01 to 0.3 μm. The dispersion particle diameter is usually of the order of 0.2 to 10 μm. In the emulsified-dispersed solution, the polyvalent isocyanate causes a polymerization reaction at the boundary between the oil phase and the water phase, to thereby form a polyurea wall.

If polyol is added to the water phase, the polyvalent isocyanate is allowed to react with the polyol, whereby a polyurethane wall can be formed. It is preferable to maintain a high reaction temperature or to add a proper polymerization catalyst so as to accelerate the reaction rate. The polyvalent isocyanate, polyol, reaction catalyst, polyamine that forms a part of a wall material, and the like are described in detail in published documents (Polyurethane Handbook edited by IWATA Keiji, The Nikkan Kogyo Shimbun, Ltd., 1987).

As the polyvalent isocyanate compound used as the raw material for the microcapsule wall, it is preferable to use a tri- or higher functional isocyanate compound, optionally together with a difunctional isocyanate compound. Examples of the isocyanate compound include dimers or trimers (biuret or isocyanurate) using, as a major raw material, diisocyanate such as xylenediisocyanate and its hydrogenated product, hexamethylenediisocyanate, tolylenediisocyanate and these hydrogenated products or isophoronediisocyanate, polyfunctional adducts of these diisocyanates and a polyol such as trimethylol propane and formalin condensates of benzeneisocyanate.

Moreover, polyol or polyamine may be added to a hydrophobic solvent which becomes the core, or a water-soluble polymer solution which becomes a dispersion medium, for use as one of the raw material of the microcapsule wall. Specific examples of these polyol and polyamine include propylene glycol, glycerin, trimethylolpropane, triethanolamine, sorbitol and hexamethylenediamine. When polyol is added, a polyurethane wall is formed.

The water-soluble polymer used in the water-soluble polymer solution for dispersing the oil phase of the capsule, that is prepared in this manner, is preferably a water-soluble polymer having a solubility of 5 or more in water at a prescribed temperature for performing emulsification. Specific examples of the water-soluble polymer include a polyvinyl alcohol and its modified product, polyacrylic acid amide and its derivative, ethylene/vinyl acetate copolymer, styrene/maleic acid anhydride copolymer, ethylene/maleic acid anhydride copolymer, isobutyrene/maleic acid copolymer, polyvinylpyrrolidone, ethylene/acrylic acid copolymer, vinyl acetate/acrylic acid copolymer, carboxymethyl cellulose, methyl cellulose, casein, gelatin, starch derivative, gum arabic and sodium alginate.

These water-soluble polymers preferably has no or less reactivity with isocyanate compounds. It is necessary to modify, in advance, compounds such as gelatin having a reactive amino group in their molecular chains in order to make non-reactive. In the case of adding a surfactant, the amount of the surfactant is preferably 0.1% to 5%, and particularly preferably 0.5% to 2%, based on the mass of the oil phase.

The emulsification may be carried out using known emulsifiers such as a homogenizer, Manton-Gaulin, ultrasonic dispersing machine and Kdmill. After the emulsification processing is finished, the emulsion is heated to 30 to 70° C. in order to accelerate a reaction for forming a capsule wall. Also, during the reaction, it is necessary to lower the provability of collision among capsules by adding water and to provide vigorous stirring to prevent coagulation among capsules.

It is also suitable to newly add a dispersant for preventing coagulation during the reaction. The generation of carbon dioxide gas is observed along with the progress of the polymerization reaction. The termination of the reaction is almost regarded as the end of the capsule wall-forming reaction. Usually, a reaction to proceed for several hours allows to produce an intended diazo compound-encapsulating microcapsules.

(Organic Base)

In the recording material of the invention, an organic base may be added to accelerate the coupling reaction between the diazo compound and the coupler.

These organic bases may be used either singly or in combination of two or more. Examples of the organic base include nitrogen-containing compounds such as tertiary amines, piperidines, piperazines, amidines, formamidines, pyridines, guanidines and morpholines.

Among these compounds, piperazines such as N,N′-bis(3-phenoxy-2-hydroxypropyl)piperazine, N,N′-bis[3-(p-methylphenoxy)-2-hydroxypropyl]piperazine, N,N′-bis[3-(p-methoxyphenoxy)-2-hydroxypropyl]piperazine, N,N′-bis(3-phenylthio-2-hydroxypropyl)piperazine, N,N′-bis [3-(β-naphthoxy)-2-hydroxypropyl]piperazine, N-3-(β-naphthoxy)-2-hydroxypropyl-N′-methylpiperazine and 1,4-bis{[3-(N-methylpiperazino)-2-hydroxy]propyloxy}benzene, morpholines such as N-[3-(Pi-naphthoxy)-2-hydroxy]propylmorpholine, 1,4-bis[(3-morpholino-2-hydroxy)propyloxy]benzene and 1,3-bis[(3-morpholino-2-hydroxy)propyloxy]benzene, piperidines such as N-(3-phenoxy-2-hydroxypropyl)piperidine and N-dodecylpiperidine and guanidines such as triphenylguanidine, tricyclohexylguanidine and dicyclohexylphenylguanidine.

In the recording material of the invention, the use amount of the organic base is preferably 0.1 to 30 parts by mass based on 1 part by mass of the diazo compound.

(Color Developing Auxiliary)

In the invention, besides the organic base, a color developing auxiliary may be added to facilitate a color developing reaction. The color developing auxiliary is a substance that enhances density of developed color during thermal recording or reduces the lowest color developing temperature. In other words, the color developing auxiliary serves to bring about a situation under which the diazo compound, basic material, coupler and the like are readily allowed to react through its ability of reducing the melting point of the coupler, basic material or diazo compound and the softening point of the capsule wall.

A phenol derivative, naphthol derivative, alkoxy-substituted benzene s, alkoxy-substituted naphthalenes, hydroxy compound, amide compound and sulfonamide compound may be added as the color developing auxiliary for use in the recording material of the invention, in the photosensitive layer so that, for example, thermal developing can be carried out rapidly and perfectly by using low energy. These compounds are considered to reduce the melting points of the coupler and the basic material or improve the heat transmittance of the microcapsule wall to thereby achieve high developed color density.

The color developing auxiliary used in the recording material of the invention may be a thermally fusible material. The thermally fusible material is material that is a solid at ambient temperature, is fused by heating, has a melting point of 50° C. to 150° C., and dissolves the diazo compound, the coupler, the basic material or the like. Specific examples of these compounds include carboxylic acid amide, N-substituted carboxylic acid amide, ketone compounds, urea compounds and esters.

(Other Additives)

In the recording material of the invention, it is preferable to use the following known antioxidants or the like from the standpoint of improving light and heat fastness of a heat-developed image or reducing the incidences of yellowing caused by light at a non-printed area after fixing.

The aforementioned antioxidant is described in, for example, European Patent Laid-Open Nos. 223739, 309401, 309402, 310551, 310552 and 459416, Germany Patent Laid-open No. 3435443, JP-A Nos. 54-48535, 62-262047, 63-113536, 63-163351, 2-262654, 2-71262, 3-121449, 5-61166 and 5-119449 and U.S. Pat. Nos. 4,814,262 and 4,980,275.

Furthermore, it is effective to use various known additives which have been conventionally used in heat-sensitive recording materials and pressure sensitive recording materials. Specific examples of these antioxidants may include compounds described in JP-A Nos. 60-107384, 60-107383, 60-125470, 60-125471, 60-125472, 60-287485, 60-287486, 60-287487, 60-287488, 61-160287, 61-185483, 61-211079, 62-146678, 62-146680, 62-146679, 62-282885, 63-051174, 63-89877, 63-88380, 63-088381, 63-203372, 63-224989, 63-251282, 63-267594, 63-182484, 01-239282, 04-291685, 04-291684, 05-188687, 05-188686, 05-110490, 05-1108437 and 05-170361 and Japanese Patent Application Publication (JP-B) Nos. 48-043294 and 48-033212.

Specific examples of these antioxidants include 6-ethoxy-1-phenyl-2,2,4-trimethyl-1,2-dihydroquinoline, 6-ethoxy-1-octyl-2,2,4-trimethyl-1,2-dihydroquinoline, 6-ethoxy-1-phenyl-2,2,4-trimethyl-1,2,3,4-tetrahydroquinoline, 6-ethoxy-1-octyl-2,2,4-trimethyl-1,2,3,4-tetrahydroquinoline, nickel cyclohexanoate, 2,2-bis-4-hydroxyphenylpropane, 1,1-bis-4-hydroxyphenyl-2-ethylhexane, 2-methyl-4-methoxy-diphenylamine and 1-methyl-2-phenylindole.

The amount of these antioxidants to be added is preferably 0.05 to 100 parts by mass, and particularly preferably 0.2 to 30 parts by mass, based on 1 part by mass of the diazo compound. The aforementioned known antioxidant may be used by including it in a microcapsule together with the diazo compound or as a solid dispersion together with the coupling component, basic material and other color developing auxiliary, or an emulsion together with an emulsion auxiliary, or alternatively in both states. It is, of course, possible to use these antioxidants either singly or in combination of two or more. It is also possible to arrange a protective layer, on the recording layer, to incorporate one or more kinds of antioxidants therein.

It is not required for these antioxidants to be added to the same layer. In the case of using these antioxidants by combining plural antioxidants, these antioxidants may be classified by structures into anilines, alkoxybenzenes, hindered phenols, hindered amines, hydroquinone derivatives, phosphorous compounds and sulfur compounds. Antioxidants having structures differing from each other may be combined, or plural antioxidants having the same structures may be combined.

Although the coupler used in the invention may be used as a solid dispersion in a water-soluble polymer together with the basic material, other color developing agents and the like by using a sand mill or the like, it is particularly preferably used as an emulsion together with a proper emulsifying auxiliary. Preferable examples of the water-soluble polymer include water-soluble polymers conventionally used in preparing the microcapsules (see, for example, JP-A No. 59-190886). In this case, the coupler, basic material and color developing auxiliary are poured in an amount of 5 to 40% by mass, respectively, based on the water-soluble polymer. The average size of particles dispersed or emulsified is preferably 10 μm or less.

A free radical generating agent (compounds that generate a free radical by irradiation with light), which is generally used for photopolymerizable compositions or the like, may be added to the recording material of the invention for the purpose of decreasing the yellowing phenomena at the background area after the recording material is fixed. Examples of such a free radical generating agent include aromatic ketones, quinones, benzoin, benzoin ethers, azo compounds, organic disulfides and acyloxym esters. The amount of the free radical generating agent to be added is preferably 0.01 to 5 parts by mass based on 1 part by mass of the diazo compound.

A polymerizable compound having an ethylenically unsaturated bond (hereinafter occasionally referred to as “vinyl monomer”) may be likewise used for the purpose of reducing yellowing. The vinyl monomer refers to the compounds which have at least one ethylenically unsaturated bond (e.g., a vinyl group and a vinylidene group) in its chemical structure and have a chemical form of a monomer or prepolymer. Examples of the vinyl monomer include unsaturated carboxylic acid and its salts, esters of unsaturated carboxylic acids and aliphatic polyhydric alcohols and amide compounds of unsaturated carboxylic acids and aliphatic polyvalent amines.

The vinyl monomer is preferably used in a ratio of 0.2 to 20 parts by mass to 1 part by mass of the diazo compound. The aforementioned free radical generating agent and vinyl monomer may be included in a microcapsule together with the diazo compound upon use. In the invention, besides the above base materials, citric acid, tartaric acid, oxalic acid, boric acid, phosphoric acid, pyrophosphoric acid or the like may be added as an acid stabilizer.

The recording material of the invention is preferably provided with a heat-sensitive layer having a solid content of 2.5 to 30 g/m² through preparing a coating solution that contains the diazo compound-encapsulating microcapsules, the coupler, the organic base and other additives, and applying the coating solution to a support such as paper or a synthetic resin film by a coating method such as a bar coating, blade coating, air knife coating, gravure coating, roll coating, spray coating, dip coating or curtain coating, followed by drying.

In the recording material of the invention, the microcapsule, the coupler, the base and the like may be contained in the same layer. The recording material may also have a laminate-type structure in which these materials are contained in different layers separately. Also, the heat-sensitive layer may be applied after an intermediate layer, as described in Japanese Patent Application No. 59-177669, is formed on the support.

<Support>

As the support used in the recording material of the invention, paper supports used for usual pressure sensitive paper and heat-sensitive paper and dry- or wet-type diazo copying papers may be used. Besides the above paper supports, neutralized paper which is sized by a neutral sizing agent such as an alkylketene dimer and has a pH of 5 to 9 (those described in Japanese Patent Application No. 55-14281), paper which fulfills the relation between Stöckigt sizing degree and meter basic weight and has a Beck smoothness of 90 seconds or more as described in JP-A No. 57-116687, paper having an optical surface roughness of 8 μm or less and a thickness of 30 to 150 μm or less as described in JP-A No. 58-136492, paper having a density of 0.9 g/cm³ or less and an optical contact interval of 15% or more as described in JP-A No. 58-69091, paper which is made from pulp beaten to a degree of 400 ml (400 cc) or more in terms of Canada standard freeness (JIS P8121) and prevents a coating solution from penetrating thereinto as described in JP-A No. 58-69097, paper improved in developed color density and resolution by using, as a coating surface, the gross surface of base paper made by a Yankee machine as described in JP-A No. 58-65695 and paper improved in coatability by processing base paper by corona discharge treatment as described in JP-A No. 59-35985.

Also, the material for the synthetic resin film used as the support may be selected optionally from known materials which has dimensional stability so that they are not deformed by heating during the developing process. Examples of such a film include films of polyesters such as a polyethylene terephthalate and polybutylene terephthalate, films of cellulose derivatives such as cellulose triacetate films, polystyrene films, polypropylene films and polyolefin films such as a polyethylene. These films may be used either singly or as a laminate of films. As to the thickness of the support, a support having a thickness of 20 to 200 μm is used.

<Protective Layer>

It is preferable that the recording material of the invention be further provided with a protective layer (hereinafter simply referred to as “protective layer” in some cases) including, as major components, a polyvinyl alcohol and the like to which various pigments and a releasing agent are added, on the heat-sensitive recording layer in order to prevent sticking and head grimes when printing on the heat-sensitive recording layer via a thermal head and impart water resistance to the recording material.

<Recording Method>

When the recording surface of the recording material of the invention which as obtained above is heated by a thermal head or the like, the polyurea or polyurethane capsule wall is softened, which allows the coupler and the base compound to migrate outside of the capsule to thereby develop a color. After recording, irradiation is conducted with light having a wavelength of the diazo compound, whereby the diazo compound is decomposed to lose its ability of reacting with the coupler, and thus the image is fixed.

As a fixing light source, various fluorescent lamps, xenon lamps or mercury lamps are used. It is preferable that respective emitting spectrum of these lamps almost correspond to the absorption spectrum of the diazo compound used in the recording material such that light fixing can be accomplished efficiently. Also, the recording material (heat-sensitive recording material) is exposed to light by using a manuscript to decompose the diazo compound at an area other than the area where an image is formed to thereby form a latent image, and then heated to develop the recording material to thus form an image.

### EXAMPLES

The present invention will now be explained in more detail by way of examples, which, however, are not intended to be limiting of the invention. In these examples, all “parts” are by weight, unless otherwise indicated.

### Synthesis Examples

### Synthesis Example 1

### Synthesis of Compound A-97 of Present Invention

75.8 parts of 5-decanecarbonylamino-2-butoxyhydrazine, 27.5 parts of pivaloylacetonitrile, 14.2 parts of acetic acid and 23.2 parts of potassium acetate were dissolved in 400 parts of ethanol and stirred at 90° for 2 hours. This reaction solution was cooled to 0° C., to which was added 200 parts of water to precipitate crystals, followed by filtration. The obtained crude product was concentrated by being subjected to column chromatography (hexane/ethyl acetate=2/1), followed by recrystallization using ethanol. As a result, 25.2 parts of Compound A-97 of the present invention was produced as white crystals.

¹H-NMR (CDCl₃) δ (TMS, ppm) 0.82-0.96 (m, 6H), 1.21-1.98 (m, 19H), 1.41 (t, 2H), 1.59 (t, 2H), 1.68 (t, 2H), 2.12 (t, 2H), 3.96 (m, 4H), 5.54 (s, 1H), 6.91 (d, 1H), 7.20 (d, 1H), 7.91 (dd, 1H), 8.52 (brs, 1H)

### Synthesis Example 2

### Compound A-98

Using the corresponding hydrazine and pivaloylacetonitrile, Compound A-98 of the present invention was produced in a similar manner to Synthesis Example 1.

¹H-NMR (CDCl₃) δ (TMS, ppm) 0.88 (t, 3H), 1.20-1.40 (m, 25H), 1.57-1.65 (m, 2H), 1.67-1.78 (m, 2H), 1.90 (s, 3H), 3.90-4.01 (m, 4H), 5.48 (s, 1H), 6.88 (d, 1H), 7.32 (d, 1H), 7.78 (dd, 1H), 8.52 (brs, 1H)

### Synthesis Example 3

### Compound A-99

Using the corresponding hydrazine and pivaloylacetonitrile, Compound A-99 of the present invention was produced in a similar manner to Synthesis Example 1.

¹H-NMR (CDCl₃) δ (TMS, ppm) 0.88 (t, 3H), 1.20-1.43 (m, 25H), 1.63-1.78 (m, 4H), 1.92 (s, 3H), 3.90-4.02 (m, 4H), 5.48 (s, 1H), 6.86 (d, 1H), 7.33 (d, 1H), 7.80 (dd, 1H), 8.98 (brs, 1H)

### Synthesis Example 4

### Compound A-61

34 parts of 2-methoxy-4-decylthioxyphenylhydrazine, 13 parts of pivaloylacetonitrile and 1 part of acetic acid were dissolved in 100 parts of ethanol and a reaction was allowed to cause under reflux. To this reaction solution was added 200 parts of water to precipitate crystals of a desired compound, followed by filtration. The obtained product was recrystallized using 80 parts of acetonitrile. As a result, 30 parts of Compound A-61 of the present invention was produced.

¹H-NMR (CDCl₃, 300 MHz) δ 0.8 (t, 3H), 1.2-1.3 (m, 18H), 1.3 (s, 9H), 1.6 (m, 2H), 2.9 (t, 2H), 3.8 (s, 2H), 3.9 (s, 3H), 5.5 (s, H), 6.9 (s, 1H), 7.0 (d, 1H), 7.4 (d, 1H)

### Example 1

Production of Diazo Heat-Sensitive Recording Material

(Preparation of Capsule Solution A)

2.8 Parts of a diazo compound (exemplary compound D-30) described as the above specific example and 10 parts of tricresyl phosphate were admixed with 19 parts of ethyl acetate to form a mixed uniform solution. Then, 7.6 parts of Takenate D-110N (manufactured by Takeda Chemical Industries, Ltd.) was added to the mixed solution to obtain a solution I.

The resulting solution I was added to a water phase containing 46.1 parts of an aqueous 8% by mass solution of gelatin phthalate, 17.5 parts of water and 2 parts of an aqueous 10% solution of sodium dodecylbenzenesulfonate, and the resultant mixture was emulsified and dispersed under the conditions of 40° C. and 10,000 rpm. 20 Parts of water was added to the obtained emulsion and then homogenized, and further stirring was provided to run a capsule reaction at 40° C. for 3 hours, thereby obtaining a capsule solution A. The particle diameter of the capsule was 0.35 μm.

(Preparation of Coupler Solution B)

4 Parts of a coupler (exemplary compound (A-1), manufactured by Tokyo Kasei Kogyo Co., Ltd., 5-amino-3-methyl-1-phenylpyrazole) described as the above specific example, 2 parts of triphenylguanidine, 0.64 parts of tricresyl phosphate and 0.32 parts of diethyl maleate were dissolved in 8 parts of ethyl acetate to obtain a solution II. The obtained solution II was added to a water phase that had been obtained by thoroughly mixing 32 parts of an aqueous 15% by mass solution of a lime-treated gelatin, 5 parts of an aqueous 10% solution of sodium dodecylbenzenesulfonate and 30 parts of water at 40° C., and then emulsified and dispersed for 10 minutes using a homogenizer under the conditions of 40° C. and 10,000 rpm. The resulting emulsion was stirred at 40° C. for 2 hours to remove ethyl acetate. The mass of the volatized ethyl acetate and water was compensated by adding water to obtain a coupler solution B.

(Preparation of Coating Solution C)

6 Parts of a capsule solution A, 4.4 parts of water and 1.9 parts of an aqueous 15% by mass solution of a lime-treated gelatin were uniformly mixed at 40° C., to which was added 8.3 parts of the coupler solution B and thoroughly mixed to obtain a heat-sensitive recording layer coating solution C.

(Preparation of Protective Layer Coating Solution D)

32 Parts of an aqueous 10% solution of a polyvinyl alcohol (polymerization degree: 1700, saponification degree: 88%) and 36 parts of water were mixed uniformly to obtain a protective layer coating solution D.

(Application of Coating)

The heat-sensitive recording layer coating solution C and the protective layer coating solution D were applied in this order, step by step, to a print paper support that had been obtained by laminating polyethylene on high-quality paper using a wire bar, followed by drying at 50° C. to thereby prepare a desired diazo heat-sensitive recording material. The coating amounts (solids content) were 6.4 g/m² and 1.05 g/m², respectively.

Evaluation

(Raw Stock Storability)

First, the resulting diazo heat-sensitive recording sheet was stored at ambient temperature (about 22° C.) for 48 hours. Then, thermal printing was carried out to obtain an image on the diazo heat-sensitive recording layer by using a thermal head (KST type) manufactured by Kyocera Corporation and by selecting the value and pulse width of the power applied to the thermal head such that a recording energy was 0 to 40 mJ/mm² per unit area, to thereby obtain an image. Then, the entire surface of the diazo heat-sensitive recording layer was irradiated with light using a ultraviolet lamp having an emission central wavelength of 450 nm and a power of 40 W for 15 seconds to thus fix the image. Thereafter, the color developed are and the background area in the resulting sample was measured for density using a Macbeth densitometer.

Next, the diazo heat-sensitive recording sheet was likewise stored at 60° C. under a relative humidity of 30% for 72 hours, then an image was formed and fixed in the same manner as above. The color developed area and the background area were measured for density using a Macbeth densitometer, to compare a difference in density at the color developed area and the background area between before and after the accelerated aging to evaluate raw stock storability. The results are shown in Table 3.

(Light Fastness)

The samples in which color was developed and fixed as described above were irradiated continuously with light for 48 hours using a light fastness tester with a 32,000 Lux. Fluorescent lamp to assess a change in colors at the image area and at the background area between before and after the samples were irradiated with light. In this assessment, a change in density when the initial reflection density (developed color density at the image area before the samples were irradiated with light) measured using a Macbeth densitometer was about 1.1 was determined. The results are shown in Table 3.

### Example 2

A recording material was manufactured in the same manner as in Example 1, except that a diazonium salt (D-38) was used in place of the diazonium salt (D-30) to obtain a capsule solution, and an image was formed on the recording material. Evaluation was made in the same manner as in Example 1. The results are shown in Table 3.

### Example 3

A recording material was manufactured in 1 as in Example 1, except that a diazonium salt (D-66) was used in place of the diazonium salt (D-30) to produce a capsule solution, and an image was formed on the recording material. Evaluation was made in the same manner as in Example 1. The results are shown in Table 3.

### Example 4

A recording material was manufactured in the same manner as in Example 2, except that a coupler compound (A-16) was used in place of the coupler compound (A-1) to give a coupler solution B, and an image was formed on the recording material. Evaluation was made in the same manner as in Example 1. The results are shown in Table 3.

### Example 5

A recording material was manufactured in the same manner as in Example 3, except that a coupler compound (A-17) was used in place of the coupler compound (A-1) to yield a coupler solution B, and an image was formed on the recording material. Evaluation was made in the same manner as in Example 1. The results are shown in Table 3.

### Example 6

A recording material was manufactured in the same manner as in Example 3, except that a coupler compound (A-40) was used in place of the coupler compound (A-1) to yield a coupler solution B, and an image was formed on the recording material. Evaluation was made in the same manner as in Example 1. The results are shown in Table 3.

### Example 7

A recording material was manufactured in the same manner as in Example 3, except that a coupler compound (A-61) was used in place of the coupler compound (A-1) to yield a coupler solution B, and an image was formed on the recording material. Evaluation was made in the same manner as in Example 1. The results are shown in Table 3.

### Example 8

A recording material was manufactured in the same manner as in Example 3, except that a coupler compound (A-67) was used in place of the coupler compound (A-1) to yield a coupler solution B, and an image was formed on the recording material. Evaluation was made in the same manner as in Example 1. The results are shown in Table 3.

### Example 9

A recording material was manufactured in the same manner as in Example 3, except that a coupler compound (A-75) was used in place of the coupler compound (A-1) to yield a coupler solution B, and an image was formed on the recording material. Evaluation was made in the same manner as in Example 1. The results are shown in Table 3.

### Example 10

A recording material was manufactured in the same manner as in Example 3, except that a coupler compound (A-76) was used in place of the coupler compound (A-1) to yield a coupler solution B, and an image was formed on the recording material. Evaluation was made in the same manner as in Example 1. The results are shown in Table 3.

### Comparative Example 1

A recording material was manufactured in the same manner as in Example 1, except that 2,5-diheptyloxyacetoanilide was used in place of the coupler compound (A-1) to afford a coupler solution B, and an image was formed on the recording material. Evaluation was made in the same manner as in Example 1. The results are shown in Table 3.

### Comparative Example 2

A recording material was manufactured in the same manner as in Example 3, except that 2,5-diheptyloxyacetoanilide was used in place of the coupler compound (A-1) to prepare a coupler solution B, and an image was formed on the recording material. Evaluation was made in the same manner as in Example 1. The results are shown in Table 3.

With regard to the recording materials manufactured in Examples 1 to 10 and Comparative Examples 1 and 2, the results of raw stock storability (at an image area before and after the accelerated aging test) and preserving stability at the color developed area (light fastness) are shown below.

TABLE 3

| | | Developed color density | | | |
|---|---|---|---|---|---|
| | | (image area) | | | |
| | Developed | Before | After | Color density (image area) | |
| | color hue | Accelerated | Accelerated | Before Irradiation | After Irradiation |
| | λ max (nm) | Aging | Aging | with Light | with Light |
| Example 1 | 435 | 1.40 | 1.30 | 1.1 | 0.95 |
| Example 2 | 440 | 1.40 | 1.35 | 1.1 | 0.90 |
| Example 3 | 440 | 1.35 | 1.35 | 1.1 | 0.95 |
| Example 4 | 440 | 1.40 | 1.30 | 1.1 | 0.95 |
| Example 5 | 445 | 1.40 | 1.35 | 1.1 | 0.90 |
| Example 6 | 445 | 1.40 | 1.35 | 1.1 | 1.00 |
| Example 7 | 440 | 1.40 | 1.35 | 1.1 | 1.05 |
| Example 8 | 445 | 1.40 | 1.35 | 1.1 | 1.00 |
| Example 9 | 445 | 1.35 | 1.35 | 1.1 | 1.00 |
| Example 10 | 445 | 1.40 | 1.35 | 1.1 | 1.00 |
| Comparative | 440 | 1.40 | 1.25 | 1.1 | 0.85 |
| Example 1 | | | | | |
| Comparative | 450 | 1.35 | 1.30 | 1.1 | 0.70 |
| Example 2 | | | | | |

### Example 11

A recording material was manufactured in the same manner as in Example 1, except that a coupler compound (A-97) was used in place of the coupler compound (A-1) to prepare a coupler solution B, and an image was formed on the recording material. The obtained recording material was evaluated in the same manner as in Example 1, and further for light fastness at the background area (unrecorded area). The results are shown in Table 4.

(Light Fastness at Background Area)

The samples in which color was developed and fixed as described above were irradiated continuously with light for 144 hours using a light fastness tester with a 32,000 Lux. Fluorescent lamp to assess discoloration at the image area and at the background area (unrecorded area) between before and after the samples were irradiated with light. Assessment was made by subtracting the value of density after light irradiation from the value of density before light irradiation, obtained using a Macbeth densitometer, to thereby find an increase in density at the background area (unrecorded area). The results are shown in Table 4.

### Example 12

A recording material was manufactured in the same manner as in Example 1, except that a coupler compound (A-98) was used in place of the coupler compound (A-1) to yield a coupler solution B, and an image was formed on the recording material. Evaluation was made in the same manner as in Example 11. The results are shown in Table 4.

### Example 13

A recording material was manufactured in the same manner as in Example 1, except that a coupler compound (A-99) was used in place of the coupler compound (A-1) to yield a coupler solution B, and an image was formed on the recording material. Evaluation was made in the same manner as in Example 11. The results are shown in Table 4.

### Example 14

A recording material was manufactured in the same manner as in Example 1, except that a coupler compound (A-103) was used in place of the coupler compound (A-1) to yield a coupler solution B, and an image was formed on the recording material. Evaluation was made in the same manner as in Example 11. The results are shown in Table 4.

### Example 15

A recording material was manufactured in the same manner as in Example 1, except that a coupler compound (A-105) was used in place of the coupler compound (A-1) to yield a coupler solution B, and an image was formed on the recording material. Evaluation was made in the same manner as in Example 11. The results are shown in Table 4.

### Example 16

A recording material was manufactured in the same manner as in Example 11, except that a diazonium compound (D-66) was used in place of the diazonium compound (D-30) to yield a capsule solution, and an image was formed on the recording material. Evaluation was made in the same manner as in Example 11. The results are shown in Table 4. The recording materials of Comparative Examples 1 and 2 were assessed in a similar manner to the foregoing, and the obtained results are shown in Table 4.

TABLE 4

| | | | Light Fastness at |
|---|---|---|---|
| | | | Unrecorded Area |
| | Developed | Developed Color | (Increase in Developed |
| | Color | Density (image | Color Density) after |
| | Hue λmax | area) Before Light | Light Irradiation |
| | (nm) | Irradiation (O.D.) | ( [symbol] O.D.) |
| Example 11 | 435 | 1.46 | 0.10 |
| Example 12 | 440 | 1.52 | 0.09 |
| Example 13 | 440 | 1.48 | 0.10 |
| Example 14 | 440 | 1.45 | 0.10 |
| Example 15 | 445 | 1.44 | 0.09 |
| Example 16 | 440 | 1.43 | 0.09 |
| Comparative | 440 | 1.40 | 0.12 |
| Example 1 | | | |
| Comparative | 450 | 1.35 | 0.14 |
| Example 2 | | | |

As seen from the results shown in Tables 3 and 4, the recording materials using the coupler compound according to the present invention exhibit good raw stock storability and light fastness.

As detailed above, the present invention provides a yellow color developing type recording material using, as a color forming component, a combination of a diazo compound and a coupler, that has improved the pre-recording storability and post-recording light fastness at an image area and a non-image area.

What is claimed is:

1. A recording material comprising a support having disposed thereon a recording layer that contains a diazo compound and a compound represented by the following formula (1): 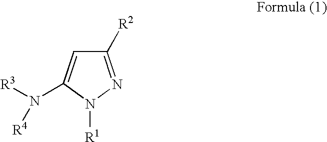
wherein, in formula (1), R¹ represents a hydrogen atom or an optionally substituted alkyl, aryl, alkylsulfonyl, arylsulfonyl, acyl, carbamoyl, acylamino, alkylsulfonylamino, arylsulfonylamino, alkoxycarbonyl or aryloxycarbonyl group; R² represents a hydrogen atom or an optionally substituted alkyl, aryl, alkoxy, aryloxy, amino, alkoxycarbonyl, aryloxycarbonyl, carbamoyl, acylamino, alkylsulfonylamino or arylsulfonamino group; and R³ and R⁴ each independently represent a hydrogen atom or an optionally substituted alkyl, aryl, alkylsulfonyl, arylsulfonyl, acyl, carbamoyl or heterocyclic group, or may be bonded to each other to form a ring.

2. The recording material according to claim 1, wherein R⁴ in formula (1) is a hydrogen atom.

3. The recording material according to claim 2, wherein the compound represented by formula (1) is a compound represented by the following formula (1-2): 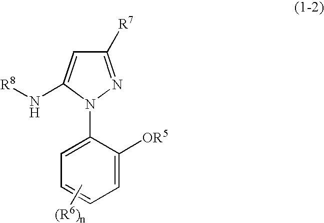
wherein, in formula (1-2), R⁵ represents a hydrogen atom or an optionally substituted alkyl or aryl group; R⁶ represents a substituent; R⁷ represents a hydrogen atom or an optionally substituted alkyl, aryl, alkoxy, aryloxy, amino, alkoxycarbonyl, aryloxycarbonyl, carbamoyl, acylamino, alkylsulfonylamino or arylsulfonylamino group; R⁸ represents a hydrogen atom or an optionally substituted alkyl, aryl, alkylsulfonyl, arylsulfonyl, acyl, carbamoyl or heterocyclic group; and n indicates an integer of 0 to 4.

4. The recording material according to claim 3, wherein the compound represented by formula (1-2) is one of the compounds represented by the following formulae (1-3), (1-4) and (1-5): 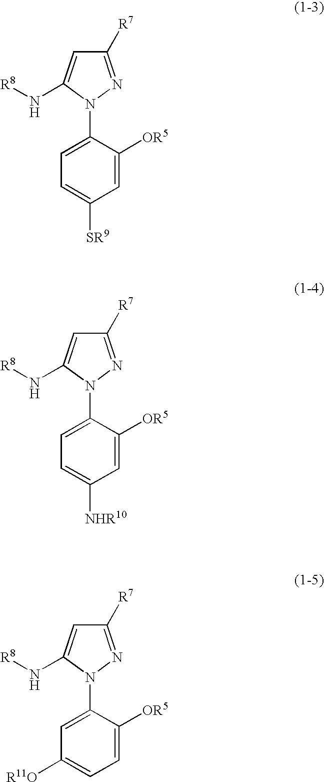
wherein, in formulae (1-3), (1-4) and (1-5), R⁹ represents an optionally substituted alkyl or aryl group; R¹⁰ represents an optionally substituted acyl, alkylsulfonyl, arylsulfonyl, carbamoyl, alkoxycarbonyl or aryloxycarbonyl group; R¹¹ represents an optionally substituted alkyl or aryl group; R⁷ represents a hydrogen atom or an optionally substituted alkyl, aryl, alkoxy, aryloxy, amino, alkoxycarbonyl or aryloxycarbonyl, carbamoyl, acylamino, alkylsulfonylamino or arylsulfonylamino group; and R⁸ represents a hydrogen atom or an optionally substituted alkyl, aryl, alkylsulfonyl, arylsulfonyl, acyl, carbamoyl or heterocyclic group.

5. The recording material according to claim 1, wherein the diazo compound is represented by the following formula (2): 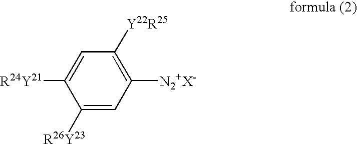
wherein, in formula (2), R²⁴ and R²⁶ each independently represent an optionally substituted alkyl, aryl, heterocyclic or acyl group; R²⁵ represents an optionally substituted alkyl, aryl, alkylsulfonyl, arylsulfonyl, acyl or heterocyclic group; Y²¹ represents an oxygen atom, a sulfur atom or a nitrogen atom; Y²² represents an oxygen atom, a sulfur atom or a single bond; Y²³ represents an oxygen atom, a sulfur atom or a hydrogen atom, with a proviso that R²⁶ is not present when Y²³ is a hydrogen atom; R²⁴ and R²⁶ may be bonded to each other to form a ring;
and X⁻ represents an anion.

6. The recording material according to claim 1, wherein the diazo compound is represented by the following formula (3) or (4): 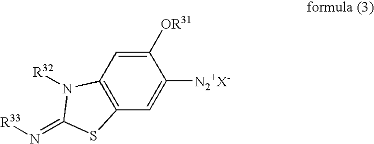
wherein, in formula (3), R³¹ and R³² each independently represent an optionally substituted alkyl or aryl group; R³³ represents a hydrogen atom or an optionally substituted alkyl or aryl group; and X⁻ represents an anion, 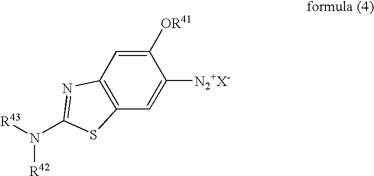
wherein, in formula (4), R⁴¹, R⁴² and R⁴³ each independently represent an optionally substituted alkyl or aryl group, or R⁴² and R⁴³ may be bonded to each other to form a ring; and X⁻ represents an anion.

7. The recording material according to claim 2, wherein the diazo compound is represented by the following formula (3) or (4): 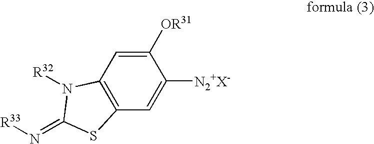
wherein, in formula (3), R³¹ and R³² each independently represent an optionally substituted alkyl or aryl group; R³³ represents a hydrogen atom or an optionally substituted alkyl or aryl group; and X⁻ represents an anion, 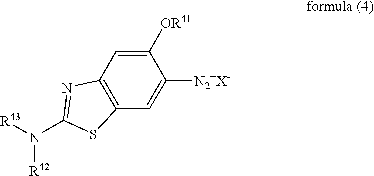
wherein, in formula (4), R⁴¹, R⁴² and R⁴³ each independently represent an optionally substituted alkyl or aryl group, or R⁴² and R⁴³ may be bonded to each other to form a ring; and X⁻ represents an anion.

8. The recording material according to claim 1, wherein the compound represented by formula (1) is used in an amount of 0.2 to 8 mol per mol of the diazo compound.

9. The recording material according to claim 1, further comprising a coupler selected from the group consisting of an active methylene compound, a phenol derivative and a naphthol derivative.

10. The recording material according to claim 1, wherein the diazo compound is encapsulated in microcapsules.

11. The recording material according to claim 2, wherein the diazo compound is encapsulated in microcapsules.

12. The recording material according to claim 1, wherein a wall of the microcapsule comprises a polyurethane or a polyurea.

13. The recording material according to claim 2, wherein a wall of the microcapsule comprises a polyurethane or a polyurea.

14. The recording material according to claim 1, wherein the support comprises a synthetic resin film selected from the group consisting of a polyester film, a cellulose derivative film and a polyolefin film.

15. The recording material according to claim 2, wherein the support comprises a synthetic resin film selected from the group consisting of a polyester film, a cellulose derivative film and a polyolefin film.
